(19) United States
(12) Patent Application Publication
(10) Pub. No.: US 2008/0260212 A1
(43) Pub. Date: Oct. 23, 2008

(54) System for indicating deceit and verity

(76) Inventors: Michael D. Moskal, Depew, NY (US); Venugopal Govindaraju, Williamsville, NY (US); Philip Charles Kilinskas, East Amherst, NY (US); Jared Delbert Holsopple, Depew, NY (US); Thomas Edward Slowe, Buffalo, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 12/008,511

(22) Filed: Jan. 11, 2008

Related U.S. Application Data
(60) Provisional application No. 60/880,315, filed on Jan. 12, 2007.

(51) Int. Cl. G06K 9/00; G06K 9/46; G06K 9/62

(52) U.S. Cl. 382/118; 382/190; 382/209

(57) ABSTRACT

An improved method for detecting truth or deceit (15) comprising providing a video camera (18) adapted to record images of a subject's (16) face, recording images of the subject's face, providing a mathematical model (62) of a face defined by a set of facial feature locations and textures, providing a mathematical model of facial behaviors (78, 82, 98, 104) that correlate to truth or deceit, comparing (64) the facial feature locations to the image (29) to provide a set of matched facial feature locations (70), comparing (77, 90, 94, 100) the mathematical model of facial behaviors to the matched facial feature locations, and providing a deceit indication as a function of the comparison (78, 91, 95, 101 or 23).

### CROSS-REFERENCE TO RELATED APPLICATIONS

This application claims the benefit of U.S. Provisional Patent Application No. 60/880,315, filed Jan. 12, 2007. The entire content of such application is incorporated by reference herein.

### TECHNICAL FIELD

The present invention relates generally to lie detection systems and, more particularly, to a system for analyzing digital video images and/or voice data of a subject to determine deceit or verity.

### BACKGROUND ART

Conventional polygraph techniques typically use questions together with physiological data from a subject answering such questions to determine deceit. The questions typically include a relevant/irrelevant test, a control test and a guilty knowledge test. The physiological data collected can include EEG, blood pressure, skin conductance, and blood flow. Readings from these sensors are then used to determine deceit or veracity. However, it has been found that some subjects have been able to beat these types of tests. In addition, the subject must be connected to a number of sensors for these prior art systems to work.

Numerous papers have been published regarding research in facial expressions. Initial efforts in automatic face recognition and detection research was pioneered by researchers like Pentland (Turk M. & Pentland A., Face Recognition Using Eigenfaces, In Proceedings of IEEE Computer Vision and Pattern Recognition, pages 586-590, Maui, Hi., December 1991) and Takeo Kanade (Rowley H A, Baluja S. & Kanade T., Neural Network Based Face Detection, IEEE PAMI, Vol. 20 (1), pp. 23-38, 1996). Mase and Pentland initiated work in automatic facial expression recognition using optical flow estimation to observe and detect facial expressions. Mase K. & Pentland A., Recognition of Facial Expression from Optical Flow, IEICE Trans., E(74) 10, pp. 3474-3483, 1991.

The Facial Action Units established by Ekman (described below) were used for automatic facial expression analysis by Ying-li Tian et al. Tian Y., Kanade T., & Cohn J., Recognizing Action Units for Facial Expression Analysis, IEEE Transactions on Pattern Analysis and Machine Intelligence, Vol. 23, No. 2, pp. 97-115, 2001. In their model for facial expression analysis, first facial feature tracking was performed to extract key points on the face. By use of a neural network, recognition of facial action units was attempted and subsequent facial expressions are assembled from the action units. In other research, an HMM based classifier was used to recognize facial expressions based on geometric features extracted from a 3D model of the face. Cohen I., Sebe N., Cozman F., Cirelo M. & Huang T., Coding, Analysis, Interpretation, and Recognition of Facial Expressions, Journal of Computer Vision and Image Understanding Special Issue on Face Recognition, 2003. The use of an appearance based model for feature extraction followed by classification using SVM-HMM was repeated by Bartlett M., Braathen B., Littlewort-Ford G., Hershey J., Fasel I., Marks T., Smith E., Sejnowski T. & Movellan J R, Automatic Analysis of Spontaneous Facial Behavior: A Final Project Report, Technical Report INC-MPLab-TR-2001.08, Machine Perception Lab, Institute for Neural Computation, University of California, San Diego, 2001. Tian et. al. proposed a combination of appearance based and geometric features of the face for an automatic facial expression recognition system (Tian Y L, Kanade T. & Cohn J., Evaluation of Gabor-Wavelet-Based Facial Action Unit Recognition in Image Sequences of Increasing Complexity, In Proceedings of the 5th IEEE International Conference on Automatic Face and Gesture Recognition (FG'02), Washington, D.C., 2002) which used gabor filters for feature extraction and neural networks for classification. Abboud et. al. (Abboud B. & Davoine F., Facial Expression Recognition and Synthesis Based on an Appearance Model, Signal Processing: Image Communication, Elsevier, Vol. 19, No. 8, pages 723-740, September, 2004; Abboud B., Davoine F. & Dang M., Statistical modeling for facial expression analysis and synthesis, Image Processing, 2003. ICIP Proceedings 2003) proposed a statistical model for facial expression analysis and synthesis based on Active Appearance Models.

Padgett and Cottrell (Padgett C., Cottrell G W & Adolphs R., Categorical Perception in Facial Emotion Classification, In proceedings of the 18th Annual Conference of the Cognitive Science Society, 1996) presented an automatic facial expression interpretation system that was capable of identifying six basic emotions. Facial data was extracted from blocks that were placed on the eyes as well as the mouth and projected onto the top PCA eigenvectors of random patches extracted from training images. They applied an ensemble of neural networks for classification. They analyzed 97 images of 6 emotions from 6 males and 6 females and achieved an 86% rate of performance.

Lyons et al. (Lyons M J, Budynek J. & Akamatus S., Automatic Classification of Single Facial Images, IEEE Transactions On PAMI, 21(12), December 1999) presented a Gabor wavelet based facial expression analysis framework, featuring a node grid of Gabor jets. Each image was convolved with a set of Gabor filters, whose responses are highly correlated and redundant at neighboring pixels. Therefore it was only necessary to acquire samples at specific points on a sparse grid covering the face. The projections of the filter responses along discriminant vectors, calculated from the training set, were compared at corresponding spatial frequency, orientation and locations of two face images, where the normalized dot product was used to measure the similarity of two Gabor response vectors. They placed graphs manually onto the faces in order to obtain a better precision for the task of facial expression recognition. They analyzed 6 different posed expressions and neutral faces of 9 females and achieved a generalization rate of 92% for new expressions of known subjects and 75% for novel subjects.

Black and Yacoob (Black M J & Yacoob Y., Recognizing Facial Expressions in Image Sequences Using Local Parameterized Models of Image Motion, International Journal of Computer Vision, 25(1):23-48, 1997) analyzed facial expressions with parameterized models for the mouth, the eyes, and the eyebrows and represented image flow with low-order polynomials. They achieved a concise description of facial motion with the aid of a small number of parameters from which they derived a high level description of facial actions. They carried out extensive experiments on 40 subjects with 95-100% correct recognition rate and 60-100% from television and movie sequences. They proved that it is possible to recognize basic emotions in presence of significant pose variations and head motion.

Essa and Pentland (Essa I. & Pentland A., Coding, Analysis, Interpretation and Recognition of Facial Expressions, IEEE Trans. On PAMI, 19(7):757-763, 1997) presented a computer vision system featuring both automatic face detection and face analysis. They applied holistic dense optical flow coupled with 3D motion and muscle based face models to extract facial motion. They located test faces automatically by using a view-based and modular eigenspace method and also determined the position of facial features. They applied Simoncelli's coarse-to-fine optical flow and a Kalman filter based control framework. The dynamic facial model can both extract muscle actuations of observed facial expressions and produce noise corrected 2D motion field via the control-theoretic approach. Their experiments were carried out on 52 frontal view image sequences with a correct recognition rate of 98% for both muscle and 2D motion energy models.

Bartlett et al. (Black M J & Yacoob Y., Recognizing Facial Expressions in Image Sequences Using Local Parameterized Models of Image Motion, International Journal of Computer Vision, 25(1):23-48, 1997) proposed a system that integrated holistic difference-image based motion extraction coupled with PCA, feature measurements along predefined intensity profiles for the estimation of wrinkles and holistic dense optical flow for whole-face motion extraction. They applied a feed-forward neural network for facial expression recognition. Their system was able to classify 6 upper FACS action units and lower FACS actions units with 96% accuracy on a database containing 20 subjects.

However, these studies do not attempt to determine deceit based on computerized analysis of recorded facial expressions. Hence, it would be beneficial to provide a system for automatically determining deceit or veracity based on the recorded appearance and/or voice of a subject.

### DISCLOSURE OF THE INVENTION

With parenthetical reference to the corresponding parts, portions or surfaces of the disclosed embodiment, merely for the purposes of illustration and not by way of limitation, the present invention provides an improved method for detecting truth or deceit (15) comprising providing a video camera (18) adapted to record images of a subject's (16) face, recording images of the subject's face, providing a mathematical model (62) of a face defined by a set of facial feature locations and textures, providing a mathematical model of facial behaviors (78, 82, 98, 104) that correlate to truth or deceit, comparing (64) the facial feature locations to the image (29) to provide a set of matched facial feature locations (70), comparing (77, 90, 94, 100) the mathematical model of facial behaviors to the matched facial feature locations, and providing a deceit indication as a function of the comparison (78, 91, 95, 101 or 23).

The camera may detect light in the visual spectrum or in the infrared spectrum. The camera may be a digital camera or may provide an analog signal and the method may further comprise the step of digitizing the signal. The image or texture may comprise several two dimensional matrices of numbers. Pixels may be comprised of a set of numbers coincidentally spacially located in the matrices associated with the image. The pixels may be defined by a set of three numbers and those numbers may be associated with red, green and blue values.

The facial behaviors may be selected from a group consisting of anger, sadness, fear, enjoyment and symmetry. The facial behavior may be anger and comprise a curvature of the mouth of the subject. The facial behavior may be sadness and comprise relative displacement of points on the mouth and a change in pixel values on or about the forehead. The facial behavior may be enjoyment and comprise relative displacements of points on the mouth and change in pixel values in the vertical direction near the corner of the eye. The facial behavior may be fear and comprise a change in pixel values on or about the forehead.

The step of matching the model facial feature locations to the image may comprise modifying the model facial feature locations to correlate to the image (68), modifying the image to correlate to the model, or converging the model to the image.

The step of comparing the mathematical model of facial behaviors to the matched facial feature locations may be a function of pixel values.

The deceit indication may be provided on a frame by frame basis and may further comprise the step of filtering deceit indication values over multiple frames. The deceit indication may be a value between zero and one.

The deceit indication may also be a function of an audio deceit indicator (21), a function of facial symmetry or a function of the speed of facial change.

In another aspect, the present invention provides an improved system for detecting truth or deceit comprising a video camera (18) adapted to record images of a subject face, a processor (24) communicating with the video camera, the processor having a mathematical model (62) of a face defined by a set of facial feature locations and textures and a mathematical model of facial behaviors that correlate to truth or deceit (78, 82, 98 104), the processor programmed to compare (64) the facial locations to the image (29) to provide a set of matched facial feature locations (70), to compare (77, 90, 94, 100) the mathematical model of facial behaviors to the matched facial feature locations, and to provide a deceit indication as a function of the facial comparison (78, 91, 95, 101 or 23).

The system may further comprise a microphone (19) for recording the voice of the subject, the microphone communicating with the processor (24) and the processor programmed to provide a voice deceit indication (25), and the deceit indication (46) may be a function of the facial comparison (23) and the voice deceit indicator (25).

The system may further comprise a biometric database (51) and the processor may be programmed to identify (50) biometric information in the database of the subject.

The processor deceit indication (46) may be a function of other information (43) about the subject.

### BRIEF DESCRIPTION OF THE DRAWINGS

FIG. 1 is a schematic of the preferred embodiment of the system.

FIG. 2 is a block diagram of the system.

FIG. 3 is a block diagram of the face localization shown in FIG. 2.

FIG. 4A-B are a representation of the segmentation shown in FIG. 3.

FIG. 5 is a block diagram of the face tracking system shown in FIG. 3.

FIG. 6 is a sample labeled image.

FIG. 7 shows a representation of the error rate for the modeling.

FIG. 8 shows accuracy in mean pixel difference in the modeling.

FIG. 9 is a plot of the frames per second for a sample test value showing three clearly distinct stages to facial localization.

FIG. 10 shows four expressions with their facial action units.

FIG. 11 is a block diagram of the anger deceit indicator.

FIG. 12 is a block diagram of the enjoyment deceit indictor.

FIG. 13 is a block diagram of the sadness deceit indictor.

FIG. 14 is a block diagram of the fear deceit indictor.

FIG. 15 is a block diagram of the voice modeling.

FIG. 16 is a representation of the voice training phase.

FIG. 17 is a plot of ROC curves.

FIG. 18 are plots of sample ROC curves.

FIG. 19 is a schematic of combinations utilizing identification models.

FIG. 20A-B are sample ROC curves for the biometric verification system using identification models.

### DESCRIPTION OF THE PREFERRED EMBODIMENT

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Lying is often defined as both actively misleading others through the verbal fabrication of thoughts or events and passively concealing information relevant or pertinent to others. The motivation for this definition is psychological, in that the physical signs that people show are the same for both forms of deception. Ekman P., Telling Lies: Clues to Deceit in the Marketplace, Politics, and Marriage. New York: Norton, 1985.

One can often assume that the stronger an emotion is felt, the more difficult it is to conceal in the face, body and voice. Frank M G & Ekman P., Journal of Personality and Social Psychology, 72, 1429-1439, 1997. The ability to detect deceit generalizes across different types of high-stakes lies. Leakage, in this context, is defined as the indications of deception that the liar fails to conceal. The assumption that leakage becomes greater with greater emotion is generally regarded as well established by the academic psychological community for the vast majority of people. Ekman P., Telling Lies: Clues to Deceit in the Marketplace, Politics, and Marriage. New York: Norton, 1985. Nevertheless, so called natural liars do exist. The people who are capable of completely containing their emotions, giving away no indication of their lies. For these rare people, it has not been determined what ability they have to inhibit their heat (far infrared) responses and their autonomic nervous system (breathing, heart rate, etc) responses.

For the general population, increases in the fear of being caught make a person's lies more detectable through the emotions shown on their face and body. The fear of being caught will generally be greatest when the interrogator is reputed to be difficult to fool, the interrogator begins by being suspicious, the liar has had very little practice and little or no record of success, the liar's personality makes them inclined to have a fear of being caught, the stakes are high, punishments are at stake, instead of a reward both rewards and punishments are at stake, the target doesn't benefit from the lie, and the punishment for being caught lying is substantial.

As the number of times a liar is successful increases, the fear of being caught will decrease. In general, this works to the liar's benefit by helping them refrain from showing visible evidence of the strong fear emotion. Importantly, fear of being disbelieved often appears the same as fear of being caught. The result of this is that if the interrogated believes that their truth will be disbelieved, detection of their lies is much more difficult. Fear of being disbelieved stems from having been disbelieved in high stakes truth telling before, the interrogator being reputed to be unfair or untrustworthy, and little experience in high stakes interviews or interrogations.

One of the goals of an interview or interrogation is to reduce the interrogated person's fear that they will be disbelieved, while increasing their fear of being caught in a lie. Deception guilt is the feeling of guilt the liar experiences as a result of lying and usually shares an inverse relationship with the fear of being caught. Deception guilt is greatest when the target is unwilling, the deceit benefits the liar, the target loses by being deceived, the target loses more or equal to the amount gained by the liar, the deceit is unauthorized and the situation is one where honesty is authorized, the liar has not been deceiving for a long period of time, the liar and target share social values, the liar is personally acquainted with the target, the target can't easily be faulted (as mean or gullible), and the liar has acted to win confidence in his trustworthiness.

Duping delight is characterized by the liar's emotions of relief of having pulled the lie off, pride in the achievement, or smug contempt for the target. Signs or leakage of these emotions can betray the liar if not concealed. Duping delight is greatest when the target poses a challenge by being reputed to be difficult to fool, the lie is challenging because of what must be concealed or fabricated, and there are spectators that are watching the lie and appreciate the liar's performance. Ekman P., Telling Lies: Clues to Deceit in the Marketplace, Politics, and Marriage. New York: Norton, 1985.

A number of indicators of deceit are documented in prior psychological studies, reports and journals. Most behavioral indications of deceit are individual specific, which necessitates the use of a baseline reading of the individual's normal behavior. However, there are some exceptions.

Liars betray themselves with their own words due to careless errors, slips of tongue, tirades and indirect or confusing speech. Careless errors are generally caused by lack of skill, or by over confidence. Slips of tongue are characterized by wishes or beliefs slipping into speech involuntarily. Freud S., The Psychopathology of Everyday Life (1901), The Complete Psychological Works, Vol. 6, Pg. 86, New York W.W. Norton, 1976. Tirades are said to be events when the liar completely divulges the lie in an outpouring of emotion that has been bottled up to that point. Indirect or confusing speech is said to be an indicator because the liar must use significant brain power, that otherwise would be used to speak more clearly, to keep their story straight.

Vocal artifacts of deceit are pauses, rise in pitch and lowering of pitch. Pauses in speech are normal, but if they are too long or too frequent they indicate an increase in probability of deceit. A rise in voice pitch indicates anger, fear or excitement. A reduction in pitch coincides with sadness. It should be noted that these changes are person specific, and that some baseline reading of the person's normal pauses and pitch should be known beforehand.

There are two primary channels for deceit leakage in the body: gestural and autonomic nervous system (ANS) responses. ANS activity is evidenced in breathing, heart rates, perspiration, blinking and pupil dilation. Gestural channels are broken down into three major areas: emblems, illustrators and manipulators.

Emblems are culture-specific body movements that have a clearly defined meaning. One American emblem is the shoulder shrug, which means “I don't know?” or “Why does it matter?” It is defined as some combination of raising the shoulders, turning palms upward, raising eyebrows, dropping the upper eyelid, making a U-shaped mouth, and tilting the head sideways.

Emblems are similar to slips of tongue. They are relatively rare, and not encountered with many liars, but they are highly reliable. When an emblem is discovered, with great probability something significant is being suppressed or concealed. A leaked emblem is identified when only a fragment of the full fledged emblem is performed. Moreover, it is generally not performed in the “presentation position,” the area between the waist and neck. Ekman P., Telling Lies: Clues to Deceit in the Marketplace, Politics, and Marriage. New York: Norton, 1985.

Illustrators are gestures that aid in speech as it is spoken. A reduction in illustrator use, relative to the individual's standard behavior, is an indicator of deception.

Manipulators are the set of movements characterized by fidgety and nervous behavior (nail biting, adjusting hair, etc). As it is a widely held belief that a liar evidences manipulators, liars can in large part suppress their manipulators. It is therefor not a highly reliable means of detecting deceit.

Some researches believe that for some people the body may in fact provide greater leakage than the face. “The judgments made by the observers were more accurate when made from the body than from the face. This was so only in judging the deceptive videos, and only when the observers were also shown a sample of the subjects' behavior in a baseline, nonstressful condition.” Ekman P., Darwin, Deception, and Facial Expression, Annals New York Academy of Sciences, 1000: 205-221, 2003. However, this has not been tested against labeled data.

A person may display both macro-expression and micro-expressions. Micro-expressions have duration of less than ⅓ second and possibly last only for 1/25th of a second. They generally indicate some form of suppression or concealment. Macro-expressions last longer than ⅓ second and can be either truly emotionally expressive, or faked by the liar to give false impression. Ekman P., Darwin, Deception, and Facial Expression, Annals New York Academy of Sciences, 1000: 205-221, 2003. Macro-expressions can be detected simply through the measurement of the time an expression is held, which can be easily taken from the face tracking results.

Macro-Expressions are evidence of deceit when (i) a persons' macro-expressions appear simulated instead of naturally occurring (methods for recognizing these situations have been identified by Ekman with his definition of “reliable muscles”), (ii) the natural macro-expressions show the effects of being voluntarily attenuated or squelched, (iii) the macro-expressions are less than ⅔ of a second or greater than 4 seconds long (spontaneous (natural & truthful) expressions usually last between ⅔ & 4 seconds), (iv) the macro-expression onset is abrupt, (v) the macro-expression peak is held too long, (vi) the macro-expression offset is either abrupt or otherwise unsmooth (smoothness throughout implies a natural expression), (vii) there are multiple independent action units (as further described below, AUs) and the apexes of the AUs do not overlap (in other words, if the expressions are natural they will generally overlap), and (viii) the person's faces displays asymmetric facial expressions (although there will be evidence of the same expression on each side of the face, just a difference in strength). This is different than unilateral expressions, where one side of the face has none of the expression that the other side of the face has. Unilateral expressions do not indicate deceit. Each of these indicators could be used as a DI.

Micro-Expressions are evidence of deceit when they exist, as micro-expressions are generally considered leakage of emotion(s) that someone is trying to suppress, and when a person's macro-expressions do not match their micro-expressions. Micro-expressions would require high speed cameras with automatic face tracking, operating in excess of 100 frames per second in order to maintain a significant buffer between the estimated speed of the micro-expressions 1/30th of a second and their Nyquist interval ( 1/60th of a second). Provided these requirements were met, detection would only require frame-to-frame assessment of the estimated point locations. If a large shift was identified over short time, a micro-expression could be inferred.

A consensus of research in deceit detection indicates that the way people deceive is highly personal. There are no single tell-tale indicators that generalize across populations without normalizations for individual behavioral traits. Nonetheless, there are a multitude of behavioral trends that are claimed to predict deceit with poor but slightly more than random performance in segments of the population. Also, in some cases the manner under which the deceit indicators are combined can be catered to the individual, through a prior learning process.

The learning process has both a global and local component. Global learning is characterized by the analysis of behaviors in a large and diverse group of people, such that models can be created to aid in feature detection and recognition across the general population. Local learning is characterized by the act of analyzing recorded data of the interogatee, prior to interrogation, in order to build a model of their individual behavior, both during lies and during truth-telling.

The deceit indicators listed in Table 1 below were selected from literature in academic psychology as being of particular value as facial behaviors that correlate to truth or deceit.

TABLE 1
List of Facial Deceit Indicators.

| Trend-Based Indicators | Contradiction-Based Indicators |
|---|---|
| Micro-Expressions | Enjoyment: AUs 12 & 6 |
| Expression Symmetry | Sadness: AUs 1, 1 + 4 & 15 |
| Expression Smoothness | Fear: AUs 1 + 2 + 4 & 20 |
| Expression Duration | Anger: AUs 23 |
| AU Apex Overlap | Suppressed Expressions |

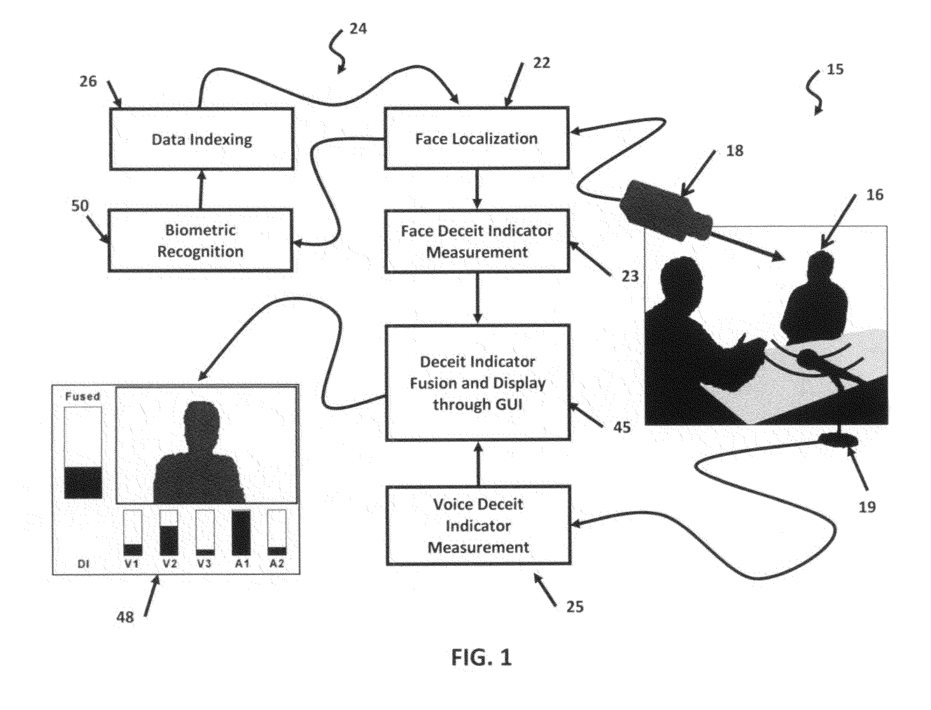

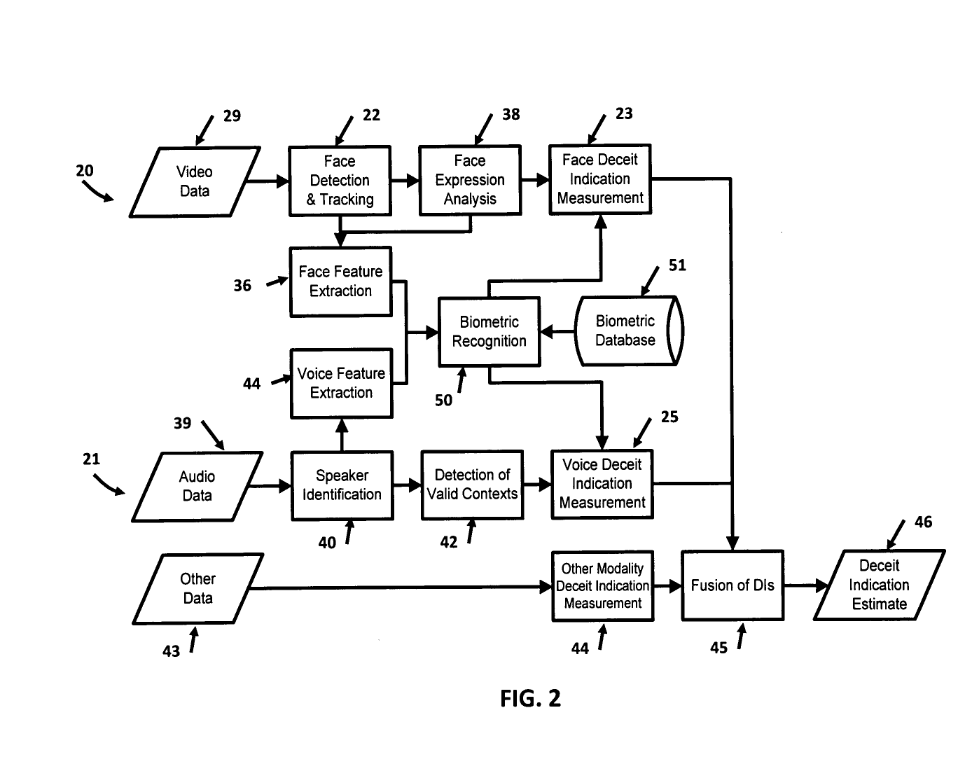

Referring now to the drawings and, more particularly, to FIGS. 1 and 2 thereof, this invention provides a system and method for indicating deceit or verity, the presently preferred embodiment of which is generally indicated at 15. As shown in FIG. 1, system 15 generally includes a camera 18 and a microphone 19 used to record the image and voice, respectively, of a subject 16. Camera 18 and microphone 19 communicate with a processor 24 having a number of processing components 20, 21 for analyzing the digital image of subject 17, the voice recording of subject 17, and using this analysis to determine deceit or verity.

FIG. 1 is a schematic outlining the high-level operation of system 15. As shown in FIGS. 1 and 2, audio data 39 and color video data 29 is recorded of a subject 17 during an interview. The video is input to a processor 24 and analyzed to localize the subject's face 22 and to measure deceit 23 based on parameters shown in the face. Thus, system 15 relies on the analysis of color video to provide an indication of deceit or verity. The system also provides for processing audio data 39 recorded of subject 17 to measure audio deceit 25 and fusing 45 this with the facial deceit indication measurement 23 to get a combined estimate of deceit 46. The deceit indication 46 is then provided in graphical form to the use on display 48. System 15 also allows for the analysis of deceit and verity to include information identified in a biometrics database 51 and to include other measures of deceit 43-44.

Due to the duration of the micro-expressions analyzed, in the preferred embodiment a non-standard, high-speed camera 18 is employed. The minimum speed of camera 18 is directly dependent upon the number of samples (frames) required to reliably detect micro-expressions. A small number of frames such as four can be used if only one frame is needed near the apex of the expression. To see the progression to and from the apex, a larger number is required, such as thirty. Thirty frames dedicated to a 1/25th of a second event translates into a camera capable of delivering 750 fps (frames per second). Such a high speed camera comes with added issues not present in standard 30 fps cameras. They require greater illumination and the processor 24 communicating with camera 18 must have sufficient bandwidth such that the increased data can be processed. An off the shelf high end workstation, with an 800 MHZ bus, will deliver in excess of 2600 fps, minus overhead (system operation, etc).

The processing of the video, audio and other data information is generally provided using computer-executable instructions executed by a general-propose computer 24, such as a server or personal computer. However, it should be noted that these routines may be practiced with other computer system configurations, including internet appliances, hand-held devices, wearable computers, multi-processor systems, programmable consumer electronics, network PCs, mainframe computers and the like. The system can be embodied in any form of computer-readable medium or a special purpose computer or data processor that is programmed, configured or constructed to perform the subject instructions. The term computer or processor as used herein refers to any of the above devices as well as any other data processor. Some examples of processors are microprocessors, microcontrollers, CPUs, PICs, PLCs, PCs or microcomputers. A computer-readable medium comprises a medium configured to store or transport computer readable code, or in which computer readable code may be embedded. Some examples of computer-readable medium are CD-ROM disks, ROM cards, floppy disks, flash ROMS, RAM, nonvolatile ROM, magnetic tapes, computer hard drives, conventional hard disks, and servers on a network. The computer systems described above are for purposes of example only. An embodiment of the invention may be implemented in any type of computer system or programming or processing environment. In addition, it is meant to encompass processing that is performed in a distributed computing environment, were tasks or modules are performed by more than one processing device or by remote processing devices that are run through a communications network, such as a local area network, a wide area network or the internet. Thus, the term processor is to be interpreted expansively.

A block diagram of system 15 is shown in FIG. 2. As shown, video data 29 is delivered to the face detector/tracker 32/33. Tracked points on the face, coupled with the video data, are passed on to be analyzed for facial expression 38. The facial expressions are then assessed for deceit, generating a facial deceit indication 33. The audio data 39 is analyzed for speaker identification 40, valid contexts are identified 42, and a subsequent voice deceit indication measurement 25 is executed. Estimates from voice and face deceit indication 23/25 are then fused together 45 to provide a final deceit indication 46.

The generation of the facial deceit indication is aided through the use of past knowledge about the subject obtained from biometric recognition 50. Prior data 51 acquired from biometric recognition can serve to aid the measurement of deceit indication in the voice component. As deceit indication is individual specific, prior knowledge of a person's deceit and/or verity can aid in recognition of unclassified events. However, prior knowledge is not necessary for the video component. The system also allows indications of deceit obtained from other data sources 43, such as traditional polygraph and thermal video, to be added to the analysis.

In system 15, the accurate and timely detection and tracking of the location and orientation of the target's head is a prerequisite to the face deception detection and provides valuable enhancements to algorithms in other modalities. From estimates of head feature locations, a host of facial biometrics are acquired in addition to facial cues for deceit. In the preferred embodiment 15, this localization is executed in high-speed color video, for practicality and speed.

In order to measure facial behaviors, however they are defined, system 15 uses a per-frame estimate of the location of the facial features. In order to achieve this, the system includes a face detection capability 32, where an entire video frame is searched for a face. The location of the found face is then delivered to a tracking mechanism 33, which adjusts for differences frame-to-frame. The tracking system 33 tracks rigid body motion of the head, in addition to the deformation of the features themselves. Rigid body motion is naturally caused by movement of the body and neck, causing the head to rotate and translate in all three dimensions. Deformation of the features implies that the features are changing position relative to one another, this being caused by the face changing expressions.

The face localization portion 22 of system 15 uses conventional algorithmic components. The design methodology followed is coarse-to-fine, where potential locations of the face are ruled out iteratively by models that leverage more or less orthogonal image characteristics. First objects of interest are sought, then faces are sought within objects of interest, and finally the location of the face is tracked over time. Objects of interest are defined as objects which move, appear or disappear. Faces are defined as relatively large objects, characterized by a small set of pixel values normally associated with the color of skin, coupled with spatially small isolated deviations from skin color coinciding with high frequency in one or more orientations. These deviations are the facial features themselves. Once faces are identified, the tracking provides for new estimates of feature locations, as the face moves and deforms frame-to-frame.

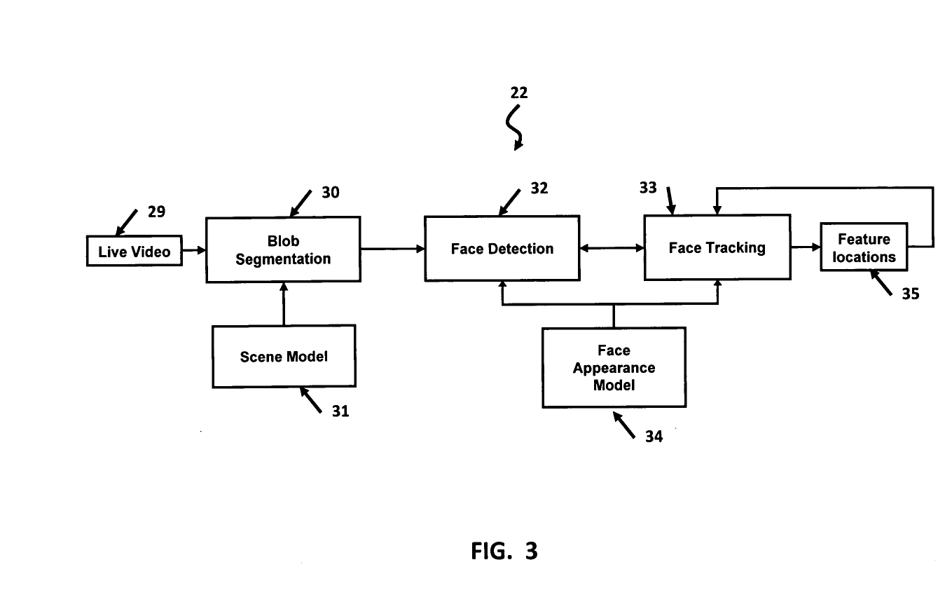

As shown in FIG. 3, live video from camera 18 is delivered to a segmenter 30. Through the use of a prior knowledge scene model 31, the segmenter 30 disambiguates the background scene from new objects that have entered it. The scene model is assembled as described in the following paragraphs. The new objects are then searched for faces by the face detector 32 described below. The location of the detected face is then delivered to the face tracker 33, which updates estimates of the face location frame-to-frame and is described below. If the tracker looses the face it passes responsibility back to the face detector. The result of the tracking is a set of estimated feature locations 35. Both the face detector and tracker leverage a face appearance model 34 to compare with the live video image 29 in order to alter estimates of the feature locations. The appearance model 34 is described below.

As discussed above, the segmentation algorithm requires a prior calculated scene model 31. This model 31 is statistical in nature, and can be assembled in a number of ways. The easiest training approach is to capture a few seconds of video prior to people entering the scene. Changes occurring to each individual pixel are modeled statistically such that, at any pixel, an estimate of how the scene should appear at that pixel is generated, which is robust to the noise level at that pixel. In the present embodiment, a conventional mean and variance measure statistical model, which provides a range of pixel values said to belong to the scene, is used. However, several other statistical measures could be employed as alternatives.

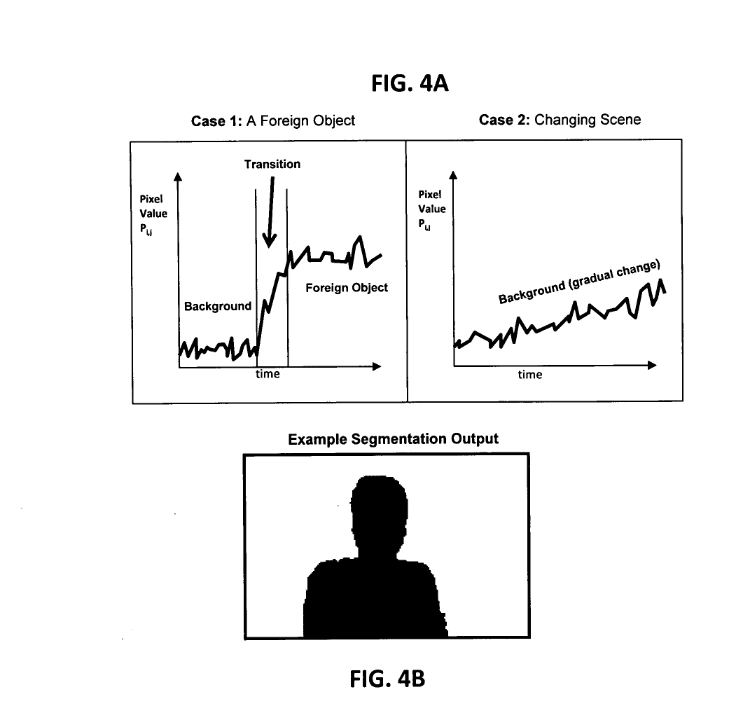

Each frame of the live video is then compared with the scene model 31. When foreign objects (people) enter the scene, pixels containing the new object will then read pixel values not within the range of values given by the scene model. The left plot of FIG. 4A presents a pixel's value plotted as a function of time. At first, the value remains in the scene model range. Then a transition takes place, and finally a foreign object is detected as being present. This is a very rapid method for ruling out areas of the image where a person could be located.

The lighting and other conditions can change the way the scene appears. System 15 measures the elapsed time for transitions in pixel value. If the transitions are slow enough, it can imply that lighting or other effects have changed the appearance of the background. The right plot of FIG. 4A shows system 15 considering these relatively slow changes as indicating changes to the background, and not new objects of interest.

Using a conventional approach, once an entire video frame's pixels have been compared to the scene model, leveraging the area of morphology is used to assess the contiguity and size of the groups (termed blobs) of pixels that were shown to be different than the scene model. Small blobs, caused by sporadic noise spikes, are easily filtered away, leaving an image that could likely appear, as in FIG. 4B.

As shown in FIG. 3, the segmentation image is delivered to the head/face detector 32, which in one formulation searches the pixels within the blobs for likeness to skin tone. This creates new blobs, termed skin tone blobs. Skin tone blobs are ordered by size, where the largest, in terms of mass (the number of pixels contained by), is chosen as the head. Skin tone has been proven as a highly unique identifier within images, and is race independent (because the intensity is not used, only the hue and saturation). Highly probable skin tone pixels are quite minute and isolated from the space of possible pixels (denoted by the deep blue background).

While for some applications this approach functions well, it can be problematic because frequency information, embodied by the facial features, is unemployed. An alternative approach is to employ the same face/head model for both detection and tracking, where the difference between the two stages is only in the programmed behavior of the model, as described below.

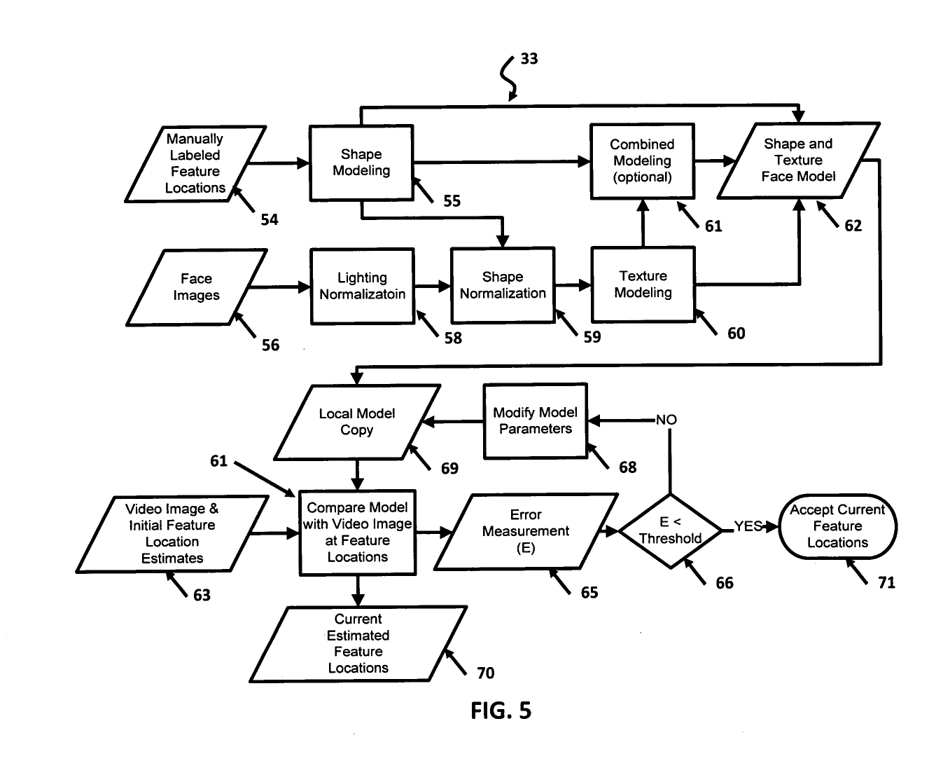

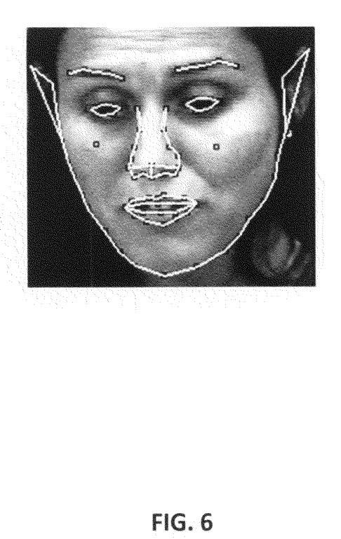

The face tracker 33 takes rough locations of the face and refines those estimates. A block diagram of face tracker 33 is shown in FIG. 5. In order to accomplish this, variants of several shape 55 and texture 60 modeling approaches are employed. The shape and texture of objects is modeled by employing a database of images of those objects, accompanied by manually labeled feature points. In the preferred embodiment, the model employs fifty-eight feature locations 33 distributed across the face. In the preferred embodiment, these locations are (1) jaw, upper left, (2) jaw, ⅙ to chin, (3) jaw, ⅓ to chin, (4) jaw, ½ to chin, (5) jaw, ⅔ to chin, (6) jaw, ⅚ to chin, (7) jaw, chin (center), (8) jaw, ⅙ to upper right, (9) jaw, ⅓ to upper right, (10) jaw, ½ to upper right, (11) jaw, ⅔ to upper right, (12) jaw, ⅚ to upper right, (13) jaw, upper right, (14) right eye, right corner, (15) right eye, right top, (16) right eye, middle top, (17) right eye, left top, (18) right eye, left corner, (19) right eye, left bottom, (20) right eye, middle bottom, (21) right eye, right bottom, (22) left eye, left corner, (23) left eye, left top, (24) left eye, middle top, (25) left eye, right top, (26) left eye, right corner, (27) left eye, right bottom, (28) left eye, middle bottom, (29) left eye, left bottom, (30) right eyebrow, left, (31) right eyebrow, ¼ to right, (32) right eyebrow, halfway, (33) right eyebrow, ¾ to right, (34) right eyebrow, right, (35) left eyebrow, right, (36) left eyebrow, ¼ to left, (37) left eyebrow, halfway, (38) left eyebrow, ¾ to left, (39) left eyebrow, left, (40) mouth, left corner, (41) mouth, left top, (42) mouth, middle top, (43) mouth, top right, (44) mouth, right corner, (45) mouth, right bottom, (46) mouth, middle bottom, (47) mouth, left bottom, (48) nose, top left near eye corner, (49) nose, 1/2 down, above outer left nostril, (50) nose, top of outer left nostril, (51) nose, bottom of outer left nostril, (52) nose, bottom center of left nostril, (53) nose, bottom center of nose, (54) nose, bottom center of right nostril, (55) nose, bottom of outer right nostril, (56) nose, top of outer right nostril, (57) nose, 1/2 down, above outer right nostril, and (58) nose, top right near eye corner. A sample labeled image is shown in FIG. 6.

As can be seen in FIG. 5, the training module for face appearance model 34 generates a model of the human face by employing a database of labeled images. The image data 56, with corresponding feature locations 54, serve as input. The entire set of labeled image feature locations are decomposed using a mathematical generalization, such as PCA (principal component analysis), ICA (independent component analysis) and LDA (linear discriminant analysis). These decompositions generate a base face shape 55, and associated components, which can be weighted appropriately and combined with the base to produce a wide variety of face shapes. The base face shape 55 is then employed to normalize 59 every image in the database to the mean face shape. The pixel values of the shape-normalized faces are also normalized for lighting differences 58 using histogram equalization, a common technique for reducing ill effects of lighting upon image analysis algorithms. The resulting shape-lighting-normalized images are decomposed using any of the above listed techniques, producing the texture model 60. In some cases, the resulting decompositions in shape and pixel data may be combined into vectors where a third decomposition is performed again 61. The decompositions are assembled to create a model 62, which is stored in a file and can be loaded at the time of tracking.

The tracker operates upon a video image frame 63 with corresponding initial estimates 70 of the feature locations 33. The initial estimates of feature locations can be derived from the face detection mechanism, simply from the prior frame's tracked locations, or from a separate estimator. The tracker compares 64 the incoming image data at the feature locations 33 with the model 62 both in texture and shape. The comparison can be realized in a myriad of ways, from simple methods such as image subtraction to complicated methods which allow for small amounts of local elasticity. The result of the image comparison is the generation of an error measurement 65, which is then compared with an experimentally derived threshold 66. If the error is larger than the threshold, it is employed to modify the model parameters 68, effecting the translation, scale, rotation, and isolated shape of the model. The updated model 69 is then compared again with the same image frame 63, resulting in new estimated feature locations and a new error measurement. If the error measurement is smaller than the threshold, the current estimated feature locations are accepted 71, and processing upon that particular video image frame declared complete.

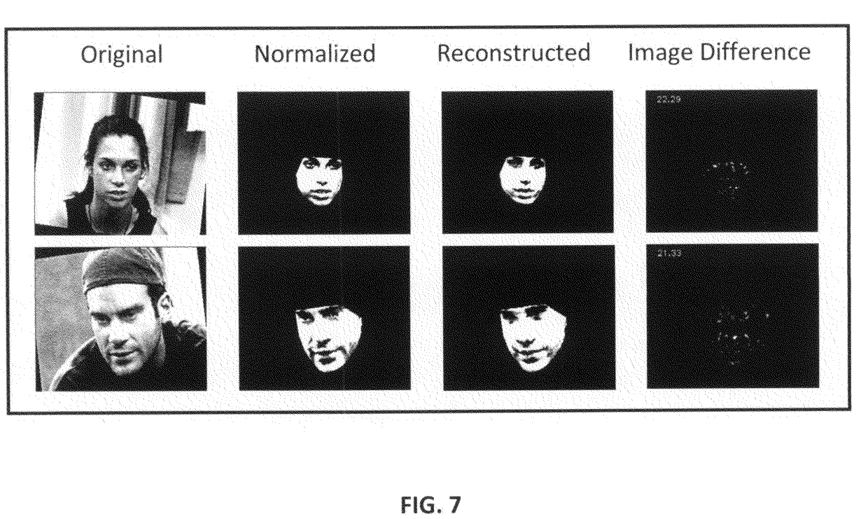

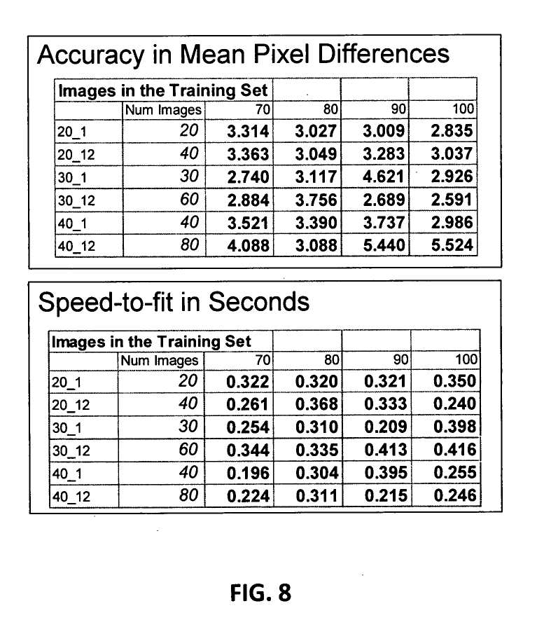

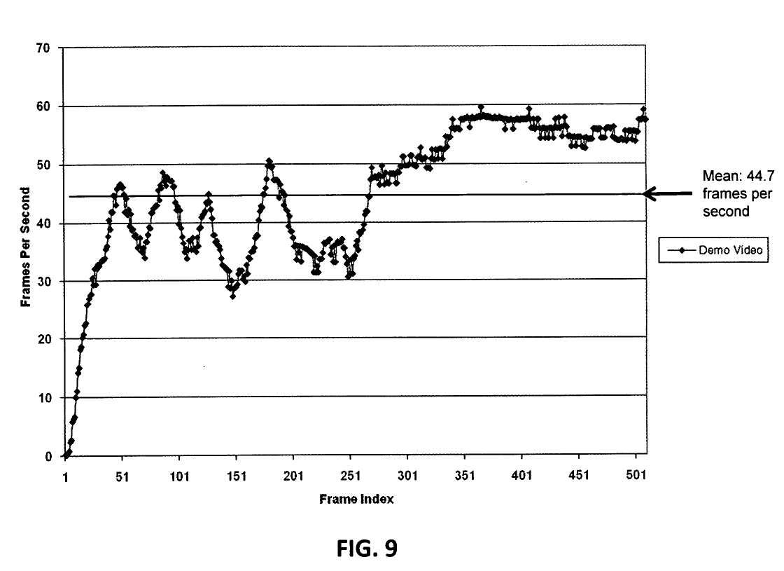

FIG. 7 depicts the amount of error if the model is tasked with recreation of a face using only modeled components. As shown, the error is quite low. FIG. 8 indicates the accuracy in mean pixel difference in the training phase, showing that a model trained with 60 images was superior to the others. Coincidentally, it also took the longest to fit the model. FIG. 9 is a graph, for a sample test video, of the frames per second, showing 3 clearly distinct stages to the facial search and analysis. During the first 45 frames the face is initially found. Between frames 45 and 275, the model is learning the individual specific facial structure of the individual depicted. After that point, the face is tracked using the learned model.

Once the mathematical model of a face, and in particular the set of facial feature locations and textures 33, has been matched to the digital image to provide a set of matched facial feature locations 70, system 15 then uses a mathematical model of facial behaviors that correlate to truth or deceit. If the incoming transformed data matches the trained facial behavior models, deceit is indicated 23.

The facial behaviors used in system 15 as the basis for the model and comparison are derived from a system for classifying facial features and research regarding how such facial features indicate deceit. Ekman has identified a number of specific expressions which are useful when searching for evidence of suppressed emotion. Ekman P., Telling Lies: Clues to Deceit in the Marketplace, Politics, and Marriage, New York: Norton, 1985. These expressions rely upon what Ekman refers to as “reliable muscles”, which cannot be voluntarily controlled by the vast majority of people. For example, Ekman has shown that there is a measurable difference between a true smile (coined a “Duchenne Smile”) and a fake or “polite” smile (coined a “Non-Duchenne Smile”). Duchenne Smiles stimulate both the zygomatic major muscle (AU 12) and the orbicularis oculi muscle (AU 6). Non-Duchenne Smiles stimulate only the zygomatic major muscle. The zygomatic major muscle is the muscle that moves the mouth edges upward and broader. The orbicularis oculi lateralis muscles encircle each eye, and aid in restricting and controlling the skin around the eyes. Orbicularis oculi lateralis muscles cannot be moved into the correct smile position voluntarily by most of the population. Only a natural feeling of happiness or enjoyment can move these muscles into the proper happiness position. Ekman believes that the same analogy is true for several emotions. Ekman, Friesen and Hager have created a system to classify facial expressions as sums of what they call fundamental facial “Action Units” (AUs), which are based upon the underlying musculature of the face. Ekman P., Friesen W V & Hager J C, The Facial Action Coding System, Salt Lake City: Research Nexus eBook, 2002. In the preferred embodiment, four contradiction-based indicators, listed in Table 2 below, are used. As described below, these deceit indicators (DIs) have value as facial behaviors that correlate to truth or deceit. However, it is contemplated that other DIs may be employed in the system.

TABLE 2
Preferred Embodiment Facial Deceit Indicators.
Contradiction-Based Indicators

Enjoyment: AUs 12 & 6
Sadness: AUs 1, 1 + 4 & 15
Fear: AUs 1 + 2 + 4 & 20
Anger: AUs 23

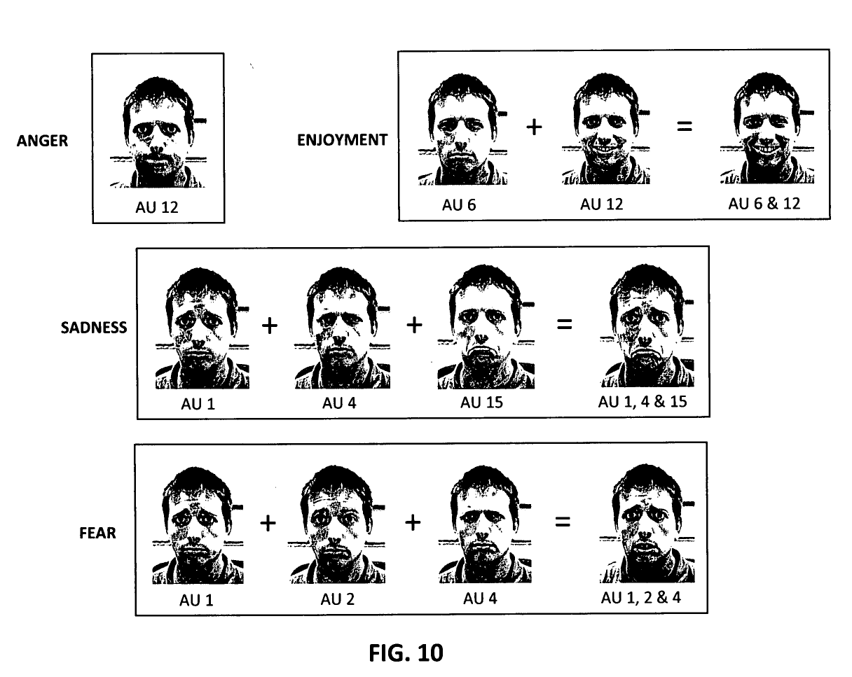

FIG. 10 shows these four reliable expressions and their associated AUs. In the preferred embodiment, the four emotions shown in FIG. 10 and their corresponding facial action units (AUs) are used as the basis of a mathematical model against which the image, coupled with the estimated facial feature locations, is compared to provide a deceit indication.

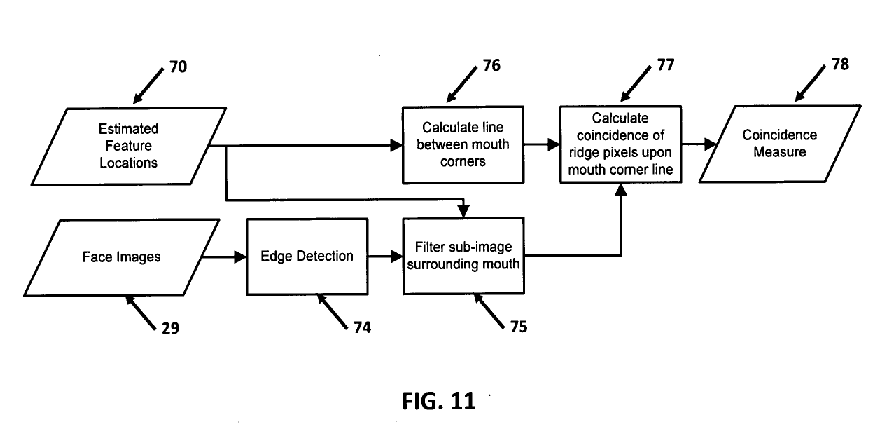

In order to fake anger, a person will evidence multiple combined expressions that are meant to trick other people into believing they are angry. Nonetheless, is it rare for a person to actually produce AU 23 without being truly angry. This anger DI is characterized by an observation that the straightness of line created by the mouth during execution of AU 23 indicates the level of verity in the subjects anger. FIG. 11 is a block diagram of the systems analysis of the anger DI. As can be seen in FIG. 11, for each image 29, the sub-image surrounding the mouth is processed for edge detection 74, and then further filtered 75 to aid in comparison with the model 70 and the line created between the mouth corners. While it is thought that any standard method for edge detection would suffice, for this work, a standard weighted Sobel filter is employed. The coincidence of the ridge pixels upon the mouth corner line 76 is calculated 77 and if the ridge pixels are entirely coincidental with the calculated line 76, it indicates verity. No coincidental ridge pixels then indicate deceit. This coincidence measure 78 is on a continuous scale, which can then be normalized to range between zero and one if desired.

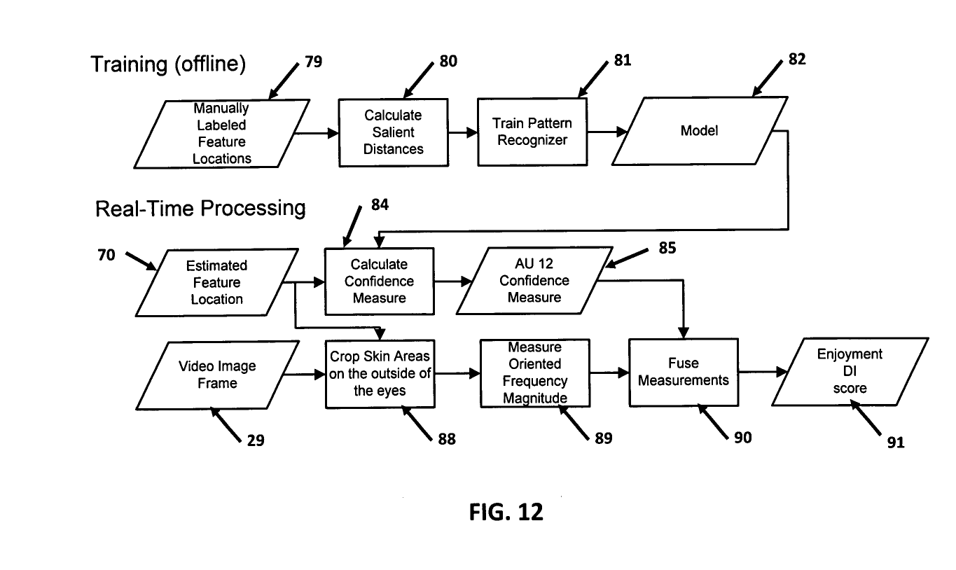

The enjoyment DI is characterized by the truthful smile including both AUs 6 & 12, and the deceitful smile evidenced by only AU 12. Thus the system detects the presence of both AUs 6 & 12 independently. FIG. 12 is a block diagram of the systems method of analyzing the enjoyment DI. As shown in FIG. 12, manually labeled feature locations 79 are delivered to the training system, which simply calculates a few salient distances 80 and then feeds these distances as vector input to a pattern recognizer 81. While it is thought that a number of standard machine learning algorithms can be used as the pattern recognizer, a Support Vector Machine (SVM) is employed in this embodiment. The trained SVM is used as a model 82 by the Real-Time Processing system. Estimated feature locations 70, from the face tracker 33, and the live video data 29 as originally acquired by camera 18 are delivered to the system for analysis. The AU 12 confidence measure 85 is derived from the pattern recognition algorithm's analysis 84 of the salient distances taken from the estimated feature locations. The areas of the face to the outside of the eyes is cropped and decomposed using oriented Gabor filters 88. The magnitude of these frequency decompositions 89 are compared with prior samples of AU 6 through euclidean distance. If the distance is small enough, as determined by thresholding, evidence of AU 6 is declared. Fusion of the measurements 90 operates as follows. If AU 6 and AU 12 are present the expression is said to be evidence of verity. If AU 12 is present but not AU 6, then the expression is said to be evidence of deceit. If AU 6 is evident but AU 12 is not, the resulting enjoyment DI score 91 is said to be undetermined.

The distances that have been identified as salient are summarized in the following Table 3.

TABLE 3
Salient Distances Identified to Facilitate Detection of the
Enjoyment and Sadness DIs.

| | |
|---|---|
| 1 | The distance between the eyes |
| 2 | The distance between the line between the eyes, and the line |
| | between the mouth corners |
| 3 | The distance between the upper and lower lips |
| 4 | The distance between the line between the eyes, and the |
| | halfway point of the upper and lower lips |

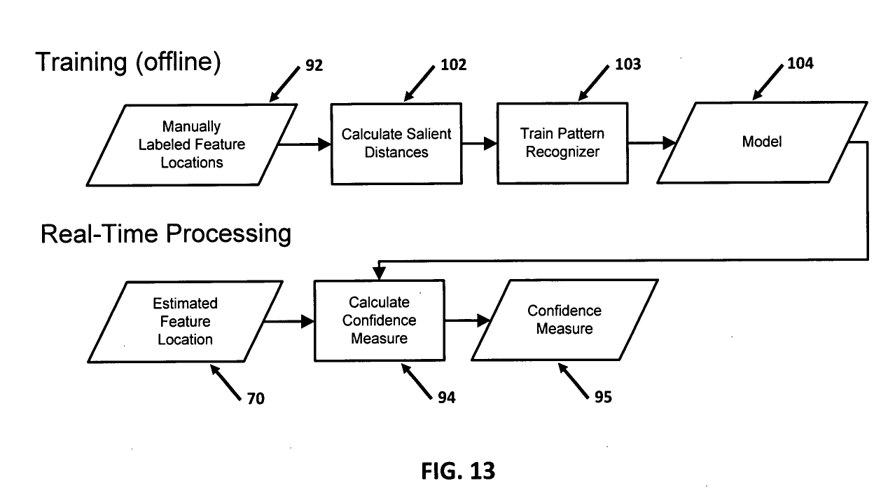

The sadness DI is characterized by the frown expressions (AU 15), one frequently seen displayed in full form mostly in children. The testing described below reinforces work by researchers in the academic psychology community, which found that AU 15 is employed quite frequently by adults, but for very short periods of time, fractions of a second. As AU 15 is the critical indicator of deceit and verity sadness expressions, the system is designed to detect this AU. FIG. 13 is a block diagram of the method the system employs to analyze the sadness DI. As shown in FIG. 13, manually labeled feature locations 92 are delivered to the training system, which simply calculates a few salient distances 102 and then feeds these distances as vector input to a pattern recognizer 103. The resulting trained pattern recognition algorithm is employed as a model 104. While a number of standard machine learning algorithm may be used as the pattern recognizer, a Support Vector Machine (SVM) was employed in the preferred embodiment. The distances that have been identified as salient are the same as for AU 12 (enjoyment) and are summarized in Table 3. The estimated feature locations 70, derived from the face tracker 33, are used to calculate a single set of salient distances which is then compared 94 by the trained pattern recognition algorithm model 104 for similarity to the deceit instances it was trained upon. The degree to which the pattern recognition algorithm declares similarity, determines the confidence measure 95.

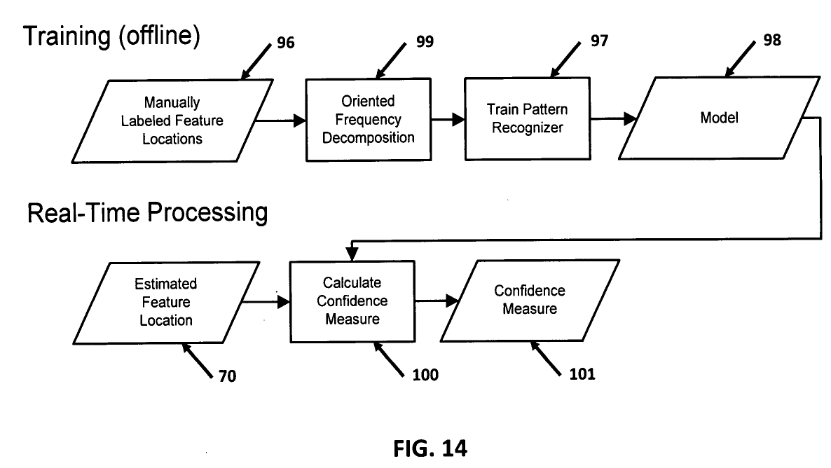

Fear is characterized by two separate expressions: a combination of AUs 1, 2 & 4 or AU 20. In the testing described below, no instances of AU 20 were found. Nonetheless, it, or its lack thereof, was included in the statistical analysis of the fear DI in order to assure completeness. FIG. 14 is a block diagram of the method of assessing the fear DI. For training, the manually labeled feature locations 96 are employed to locate skin areas in the forehead, which are cropped from the video image, and then decomposed into oriented frequency components 99 by use of Gabor filtering. These residual components 99 are employed by the pattern recognition algorithm 97 (here Support Vector Machine (SVM) is employed) for training, resulting in a trained pattern recognition algorithm 98, called the model 98. For real-time processing the estimated feature locations 70, derived from the face tracker 33, are used to crop the forehead area out from the video image. The forehead sub-image of the live video image is decomposed using Gabor filters, and compared with the model 98. The comparison 100 results in a distance measure which is used as a confidence estimate or measure 101.

System 15 was tested to determine is accuracy in detecting deceit based on video images of subjects. Acquiring quality video and audio of human subjects, while they are lying and then telling the truth, and within a laboratory setting, is difficult. The difficulty stems from a myriad of factors, the most important of which are summarized in Table 4.

TABLE 4
Problems in Generating Deceit and Verity Data from Human
Subjects in Laboratory Setting.

| | |
|---|---|
| Number of | It is necessary but difficult, due to natural time |
| Samples | restrictions, to gain many instances of deceit and |
| | verity from each study participant. |
| Number of | It is important to acquire data from a statistically |
| Participants | significant number of participants. This is especially |
| | difficult, due to the Number of Samples problem |
| | discussed above. |
| Laboratory Effect | Participants entering a laboratory setting invariably |
| | modify their behavior from the way they would |
| | deceive or tell the truth in naturally occurring |
| | circumstances. |
| Participant | Acquiring a large set of people with diverse |
| Diversity | personalities, cultures and customs is desirable, but |
| | quite difficult. |
| Verifying Deceit | Verifying lies and truth is exceptionally difficult, as |
| and Verity | the participants can't be assumed to tell the truth about |
| | or to be completely aware of their lies and truth. |
| Sufficient Stress | Lies about inconsequential issues generate little stress |
| | in people, and can have no physiological or behavioral |
| | evidence. It is necessary that participants are |
| | significantly stressed about the lie and/or truth, for the |
| | data to be valuable. |

In order to circumvent these problems, system 15 was tested using the Big Brother 3 (BB3) television show, presented by CBS. This television show was chosen specifically because its format addresses several of the most problematic issues discussed in Table 4.

The premise of the BB3 program is that the participants live together in a single house for several weeks. Every week, one participant is voted off the show by the remaining participants. Up until the weekly vote, participants take part in various competitions, resulting in luxury items, temporary seniority or immunity from the vote. Participants are frequently called into a soundproof room, by the show's host, where they are questioned about themselves and other's actions in the show. It is in these “private” interviews that lies and truths are self-verified, rectifying the ‘Verifying Deceit and Verity’ problem mentioned in Table 1. Laboratory effect is less of a problem as the house, while a contrived group living situation, is much more natural than a laboratory environment. Significant stress is also a major strength of the BB3 data, where the winning BB3 participant is awarded $500,000 at the end of the season. Thus, there is significant motivation to lie, and substantial stress upon the participants, as they are aware that failure will result in loss of a chance to win the money. The number of samples is also a strength of the test, where the best participants are tracked over the season with many show's worth of video and audio data.

A single researcher, whom viewed the show multiple times to have full understanding for the context of each event, parsed out the BB3 data against which the results of system 15 were compared. Instances of deceit and verity were found throughout for almost all of the BB3 participants. As system 15 determines deceit based on deceit indicators evident on the face, these instances were tagged as anger, sadness, fear, enjoyment or other. Moreover, stress level was rated on a 1-to-5 scale. The video and audio data was cropped out of the television program, and stored in a high quality, but versatile format for easy analysis.

In order to evaluate reliability of each DI, each DI needed to be tested by manually measuring facial movement and expression in stock video during previously identified instances of deceit and verity.

In the following four sub-sections, the test results of each reliable expression are discussed. First, the specific DI was tested for correlation with incidence of deceit/verity. Second, the algorithm was tested against the subset of deceit/verity instances which also was (de)correlated with the DI. Finally, the algorithm was tested against the entire deceit/verity set of instances.

TABLE 5
Test Results For the Anger DI.

| | GROUND TRUTH (V) | GROUND TRUTH (D) |
|---|---|---|
| AU 23 (V) | 171/191 | 2/73 |
| !AU 23 (D) | 20/191 | 71/73 |
| | AU 23 (V) | !AU 23 (D) |
| MACHINE (V) | 32/38 | 4/21 |
| MACHINE (D) | 6/38 | 17/21 |
| | GROUND TRUTH (V) | GROUND TRUTH (D) |
| MACHINE (V) | 31/37 | 5/22 |
| MACHINE (D) | 6/37 | 17/22 |

It can be seen in Table 5 above, AU 23 was highly correlated (89.5%) with true anger and highly decorrelated with deceitful anger (2.7%). Moreover, the lack of AU 23 during anger instances is highly decorrelated (10.5%) with truth and highly correlated (97.3%) with deceitful anger. The system for the detection of AU 23 performed quite well in the detection of instances of AU 23 at a rate of (84.2%), and at detection of instances of no AU 23 present, at a rate of (81.0%). The system also performed well tasked with detection of truth during anger instances (83.8%), and with the detection of deceit during anger instances (77.3%).

The salient distances in Table 3 were shown to be highly indicative of AU 12. As shown in Table 6 below, AU 6 & 12 are highly correlated with truthful enjoyment (98.4%), and highly decorrelated (20.5%) with deceitful enjoyment. It can also be seen that only AU 12 is highly decorrelated (1.6%) with truthful enjoyment, and highly correlated (79.5%) with deceitful enjoyment.

TABLE 6
Results of Testing Against the Enjoyment DI.

| | GROUND TRUTH (V) | GROUND TRUTH (D) |
|---|---|---|
| AU 6 & 12 (V) | 305/310 | 18/88 |
| Only AU 12 (D) | 5/310 | 70/88 |
| | AU 6 (V) | !AU 6 (D) |
| MACHINE (V) | 46/72 | 7/15 |
| MACHINE (D) | 26/72 | 8/15 |
| | AU 12 (V) | !AU 12 (D) |
| MACHINE (V) | 61/72 | 3/15 |
| MACHINE (D) | 11/72 | 12/15 |
| | AU 6 & 12 (V) | ONLY AU 12 (D) |
| MACHINE (V) | 44/72 | 3/15 |
| MACHINE (D) | 28/72 | 12/15 |
| | GROUND TRUTH (V) | GROUND TRUTH (D) |
| MACHINE (V) | 44/72 | 3/15 |
| MACHINE (D) | 28/72 | 12/15 |

The algorithm developed to detect the enjoyment DI performed at a rate of 63.9% when tasked with detecting only AU 6, and at a rate of 53.3% at detecting its absence. Results were better when tasked with detecting only AU 12, with a rate of 84.7%, and a rate of 80.0% in detecting its absence. The system performed the same against both filtered and unfiltered ground truth, where the rate of detection of true enjoyment instances was 61.1% and detection of deceitful enjoyment instances was 80.0%.

TABLE 7
Results of Testing Against the Sadness DI.

| | GROUND TRUTH (V) | GROUND TRUTH (D) |
|---|---|---|
| AU 15 (V) | 172/176 | 0/9 |
| !AU 15 (D) | 4/176 | 9/9 |
| | AU 15 (V) | !AU 15 (D) |
| MACHINE (V) | 61/96 | 0/9 |
| MACHINE (D) | 33/96 | 9/9 |
| | GROUND TRUTH (V) | GROUND TRUTH (D) |
| MACHINE (V) | 61/96 | 0/9 |
| MACHINE (D) | 33/96 | 9/9 |

Table 7 outlines the results of the Sadness DI. AU 15 was shown to be highly correlated with truthful sadness (97.7%), and highly decorrelated with deceitful sadness (0.0%). The lack of AU 15 was shown to be highly decorrelated (2.3%) with truthful sadness, and highly correlated (100.0%) with deceitful sadness. The system detected AU 15 at a rate of 63.5% and the absence of AU 15 at a rate of 100%. The results for the detection of deceit and verity instances were the same. These results were based upon only 9 samples of deceitful sadness.

TABLE 8
Results of Testing Against the Fear DI.

| | GROUND TRUTH (V) | GROUND TRUTH (D) |
|---|---|---|
| AU 1, 2&4 (V) | 8/10 | 4/12 |
| !AU 1, 2&4 (D) | 2/10 | 8/12 |
| | GROUND TRUTH (V) | GROUND TRUTH (D) |
| AU 20 (V) | 0/10 | 0/12 |
| !AU 20 (D) | 10/10 | 12/12 |
| | GROUND TRUTH (V) | GROUND TRUTH (D) |
| AU 1, 2&4 OR 20 (V) | 8/10 | 4/12 |
| !(AU 1, 2&4 OR 20) (D) | 2/10 | 8/12 |
| | AU 1, 2&4 (V) | !AU 1, 2&4 (D) |
| MACHINE (V) | 10/12 | 1/10 |
| MACHINE (D) | 2/12 | 9/10 |
| | AU 20 (V) | !AU 20 (D) |
| MACHINE (V) | 0/0 | 0/22 |
| MACHINE (D) | 0/0 | 22/22 |
| | GROUND TRUTH (V) | GROUND TRUTH (D) |
| MACH AU 1, 2&4 OR 20 (V) | 10/12 | 1/10 |
| MACH !(AU 1, 2&4 OR 20) (D) | 2/12 | 9/10 |
| | GROUND TRUTH (V) | GROUND TRUTH (D) |
| MACHINE (V) | 6/10 | 5/12 |
| MACHINE (D) | 4/10 | 7/12 |

As seen above in Table 8, AUs 1, 2 and 4 are highly correlated with truthful fear (80.0%), and highly decorrelated with deceitful fear (33.3%). The system was effective at detecting AUs 1, 2 and 4 at a rate of 83.3%, and their lack of existence at 10.0%. Results against unfiltered ground truth were somewhat less clear, with detection of verity instances at 60.0%, and deceit instances at 58.3%.

System 15 also includes an audio component 21 that employs deceit indicators (DIs) in voice audio samples 39. Given the assumption that deception has a detectable physiological effect on the acoustics of spoken words, the system identifies audio patterns of deception for a particular individual, and stores them for later use in order to evaluate the genuineness of a recorded audio sample. System 15 uses low-level audio features associated with stress and emotional states combined with an adaptive learning model.

The audio component of system 15 operates in two phases: the training phase, a supervised learning stage, where data is collected from an individual of interest and modeled; and the testing phase, where new unknown samples are presented to the system for classification using deceit indicators. Training data for the system is supplied by a pre-interview, in order to obtain baseline data for an individual. Ideally, this data will include instances of both truthfulness and deception, but achieving optimal performance with incomplete or missing data is also a design constraint. Design of the system is split into two major parts: the selection of useful features to be extracted from a given audio sample, and the use of an appropriate model to detect possible deception.

A significant amount of prior work has been done on extracting information from audio signals, in challenges ranging from speech recognition and speaker identification to the recognition of emotions. Success has often been achieved in these disparate fields with the use of the same low-level audio features, such as the Mel-frequency Cepstral Coefficients (MFCC), Linear Predictive Coefficients (LPC), fundamental frequency and formats, as well as their first and second order moments.

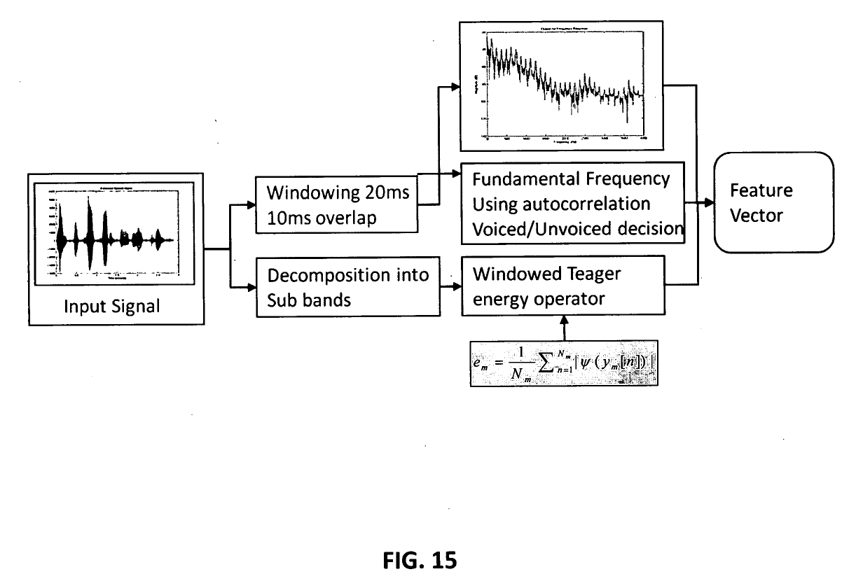

Kwon et. al. have performed experiments showing pitch and energy to be more essential than MFCCs in distinguishing between stressed and neutral speech. Kwon O W, Chan K., Hao J. & Lee, T W, Emotion Recognition by Speech Signals, Eurospeech 2003, Pages 125-128, September 2003. Further research in this area, conducted by Zhou, et. al., has shown that autocorrelation of the frequency component of the Teager energy operator is effective in measuring fine pitch variations by modeling speech phonemes as a non-linear excitation. Zhou G., Hansen J. & Kaiser J., Classification of Speech Under Stress Based on Features Derived From the Nonlinear Teager Energy Operator, IEEE ICASSP, 1998. Combining Teager energy derived features with MFCC allows the system to correlate small pitch variations with distinct phonemes for a more robust representation of the differences in audio information on a frame-by-frame basis. These low level features can be combined with higher features, such as speech rate and pausing, to gather information across speech segments. Features are extracted only for voiced frames (using pitch detection) in overlapping 20 ms frames. FIG. 15 is a block diagram of the voice modeling deceit indication module for system 15.

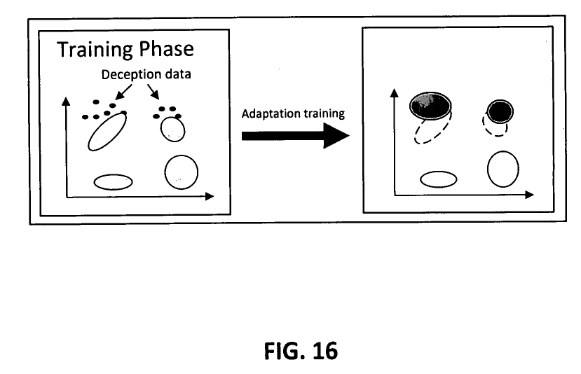

Initial training is done with data from sources that contain samples of truth and deception from particular speakers. Since all the data is from a single speaker source, a high degree of correlation between the two sets is expected. Reynolds et. al. found success in speaker verification by using adapted Gaussian mixture models (GMMs), where first a universal background model (UBM) representing the entire speaker space is generated, then specific training data for a given individual is supplied to the adaptive learning algorithm in order to isolate areas in the feature space that can best be used in classifying an individual uniquely. Reynolds D A, Quatieri T F & Dunn R B, Speaker Verification Using Adapted Gaussian Mixture Models, Digital Signal Processing 10, 19-41, 2000. This approach is especially effective in cases where there is not a large amount of training data. In order to isolate the salient differences to be used for evaluation in the testing phase, adapted Gaussian mixture models generated by the expectation maximization (EM) algorithm are implemented from feature vectors generated from small (˜20 ms) overlapping framed audio windows. First the GMM is trained using truth statements, and then the GMM is adapted by using the deceit data to update the mixture parameters, using a predefined weighted mixing coefficient. At this point, a deception likelihood measure can be calculated by taking the ratio of the scores of an inquiry statement against each model. FIG. 16 shows a representation of the training phase. After a Gaussian mixture model is created for the features extracted from the baseline verity data, adaptive learning is conducted using new deceit samples to create a deception model which gives extra weight to the areas in the feature space that are most useful in distinguishing between the two sets. This can be accomplished with a relatively small amount of deception data.

Collecting experimental data often poses a challenge in that there is a paucity of data where good quality audio capture exists of a sufficient amount of data for an individual engaged in verity and deception that can be categorically labeled for training. A further requirement is that the individual providing the data be engaged in “high stakes” deception, where the outcome is meaningful (to the participant), in order to generate the stress and underlying emotional factors needed for measurement. As with the work in deceit indication in video described above, the Big Brother 3 (BB3) data was employed for testing of the system's voice deceit indication. Labeling of speech segments as truthful or deceptive is made more reliable by the context provided in watching the entire game play out. In this way, highly reliable data for 3 individuals gathered from approximately 26 hours of recorded media was obtained. Data was indexed for each participant for deceit/verity as well as intensity and emotion. Afterwards data was extracted, segmented and verified. Only segments containing a single speaker with no overlapping speakers were used, similar to the output that would be obtained from a directional microphone.

Testing was conducted on three individuals, each with six of seven deception instances, and approximately 100 truth instances each. By training the adapted models on the deception data using the leave-one-out method, individual tests were performed for all deceit instances, and a subset of randomly selected truth instances.

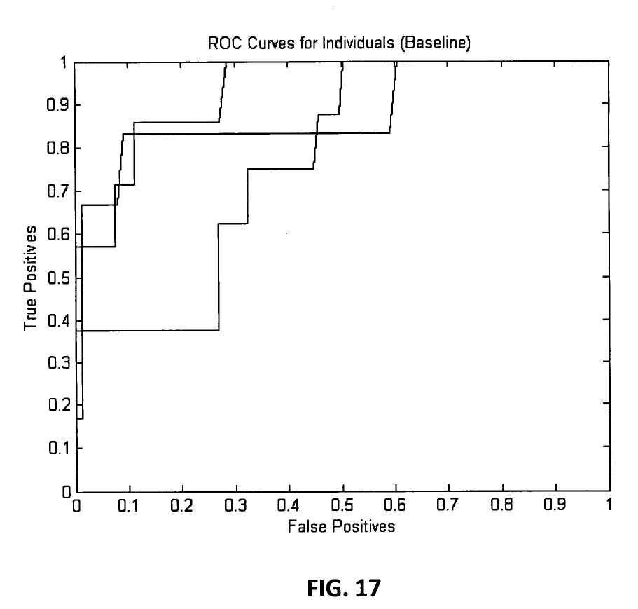

By scoring the ratio of log-likelihood sums across the entire utterance, it was possible to detect 40% of the deceit instances while generating only one false positive case. FIG. 17 shows ROC curves for three distinct subjects. Each ROC curve plots the true positive vs. false positive rate as the decision criterion is varied over all possible values. An ideal system would be able to achieve 100% true positive and 0% fase positive (the upper left corner of graph).

Since identifying baseline data for the voice detection component 21, as well as other parameters, often requires matching the subject with data in a large database holding baseline information for numerous individuals, system 15 includes a biometric recognition component 50. This component uses data indexing 26 to make identification of the subject 16 in the biometric database 51 faster, and uses fusion to improve the correctness of the matching.

Fingerprints are one of the most frequently used biometrics with adequate performance. Doing a first match of indexed fingerprint records significantly reduces the number of searched records and the number of subsequent matches by other biometrics. Research indicates that it, is possible to perform indexing biometrics represented by fixed length feature vectors using traditional data structure algorithms such as k-dimensional trees. Mhatre A., Chikkerur S. & Govindaraju V., Indexing Biometric Databases Using Pyramid Technique, Audio and Video-based Biometric Person Authentication (AVBPA), 2005. But fingerprint representation through its set of minutia point does not have such feature vector—the number of minutia varies and their order is undefined. Thus fingerprint indexing presents a challenging task and only a few algorithms have been constructed. Germain R S, Califano A. & Colville S., Fingerprint Matching Using Transformation Parameter Clustering, Computational Science and Engineering, IEEE (see also Computing in Science & Engineering), 4(4):42-49, 1997; Tan X., Bhanu B., & Lin Y., Fingerprint Identification: Classification vs. Indexing in Proceedings, IEEE Conference on Advanced Video and Signal Based Surveillance, 2003; Bhanu B. & Tan X., Fingerprint Indexing Based on Novel Features of Minutiae Triplets, Pattern Analysis and Machine Intelligence, IEEE Transactions, 25(5):616-622, 2003. But the published experimental results show that these methods can only reduce the number of searched fingerprints to around 10%, which might still be a big number for millions of enrolled templates.

System 15 uses a new improved approach to fingerprint indexing 26 over previous fingerprint matching. See Jea T Y & Govindaraju V., Partial Fingerprint Recognition Based on Localized Features and Matching, Biometrics Consortium Conference, Crystal City, Va., 2005; Chikkerur S., Cartwright A N & Govindaraju V., K-plet and Coupled BFS: A Graph Based Fingerprint Representation and Matching Algorithm, International Conference on Biometrics, Hong Kong, 2006. The idea of fingerprint index is based on considering local neighborhoods of minutia used for matching. The fingerprint matching described in the prior art is based on a tree-searching algorithm: two minutia neighborhoods are chosen in two fingerprints, and the close neighborhoods are searched for matches by a breadth-first search algorithm. In the prior art a rudimentary indexing structure of minutia neighborhoods accounted for speed improvements.

System 15 improves on this idea by providing a single global indexing tree. The nodes of the tree stand for the different types of the minutia neighborhoods, and searching the tree (going from the root to the leaf nodes) is equivalent to the previous breadth-first search matching of two fingerprints. Since the systems matching searches can begin from any minutia, it enrolls each fingerprint multiple times (equal to the number of minutia) into the same index tree. The fingerprint identification search will follow different paths in the index tree depending on the structure of local neighborhoods near each minutia. The whole identification search against an index tree should take approximately the same time as a matching of two fingerprints in verification mode.

For multimodal biometric matchers the matching scores of different modalities originate from unrelated sources, e.g. face and fingerprint. The previous experiments (Tulyakov S & Govindaraju V, Classifier Combination Types for Biometric Applications, IEEE Computer Society Workshop on Biometrics, New York, 2006) on artificial data showed that using this information in the special construction of the fusion algorithm can result in the performance improvement of the final system.

The system uses real biometric matching scores available from NIST. A fusion algorithm based on approximating probability density functions of genuine and impostor matching scores and considering their ratio as a final combined score is implemented. It is known that this method, likelihood ratio, is optimal for combinations in verification systems. The only downside is that sometimes it is difficult to accurately estimate density functions from the available training samples. The system uses Parzen kernel density estimation with maximum likelihood search of the kernel width.

The system not utilizing independence has to estimate densities using 2-dimensional kernels:

$$p ( {s}_{1} , {s}_{2} ) \approx \hat{p} ( {s}_{1} , {s}_{2} ) = \frac{1}{N} {\sum }_{i = 1}^{N} ( \frac{1}{h} ϕ ( \frac{{x}_{1} ( i ) - {s}_{1}}{h} , \frac{{x}_{2} ( i ) - {s}_{2}}{h} ) ) ,$$

φ is a Gaussian function, (x₁(i), x₂ (i)) is the i th training sample, and N is the number of training samples. As knowledge about independence is developed, the densities can be represented as products of 1-dimensional estimations:

$$p ( {s}_{1} , {s}_{2} ) = p ( {s}_{1} ) p ( {s}_{2} ) \approx \hat{p} ( {s}_{1} ) \hat{p} ( {s}_{2} ) , \hat{p} ( {s}_{1} ) = \frac{1}{N} {\sum }_{i = 1}^{N} ( \frac{1}{h} ϕ ( \frac{{x}_{1} ( i ) - {s}_{1}}{h} ) )$$

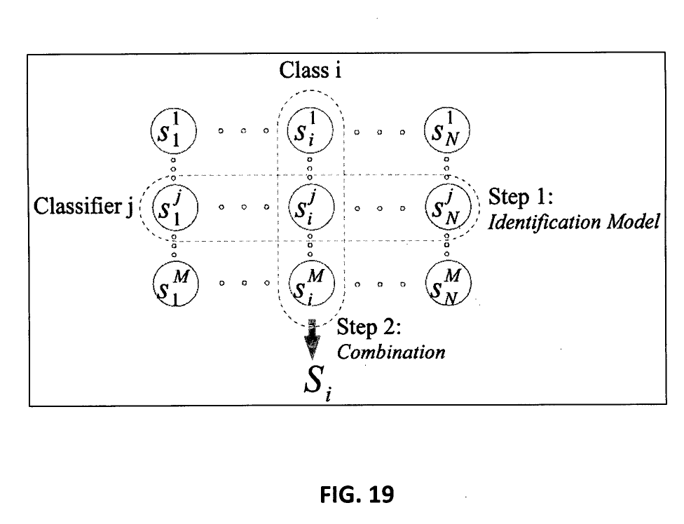

Second type estimation should statistically have less error in estimating the true densities of the matching scores and thus result in a better fusion algorithm. FIG. 19 shows sample ROCs of experiments on utilizing independence assumption in fusing face and fingerprint biometric matchers.

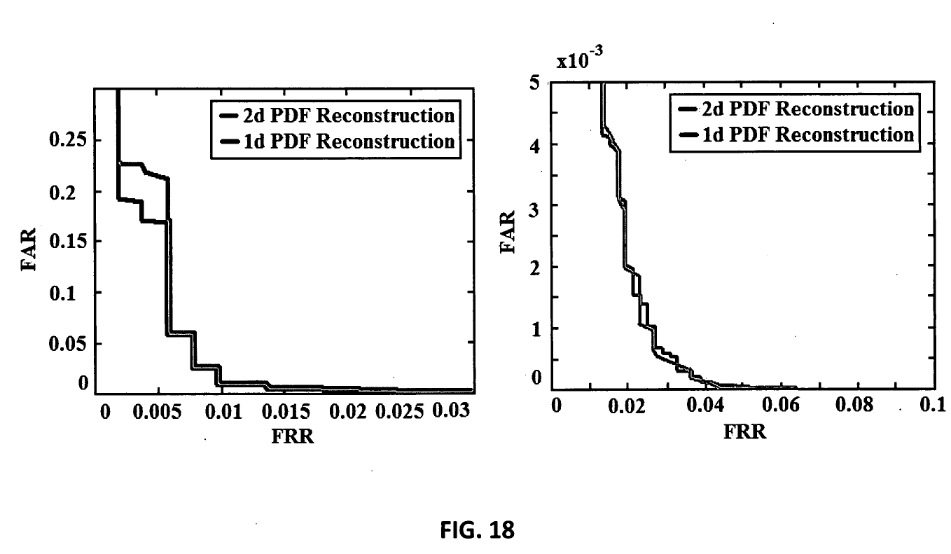

As shown in FIG. 18, experiments on real scores showed some limited improvement over the prior art. Tulyakov S. & Govindaraju V., Utilizing Independence of Multimodal Biometric Matchers, International Workshop on Multimedia Content Representation, Classification and Security, Istanbul, Turkey 2006. It is contemplated that other types of classifiers may be used. For example, a neural network of specific structure that accounts for the statistical independence of its inputs may be created.

The concept of identification model has been developed previously for making acceptance decisions in identification systems. Tulyakov S. & Govindaraju V., Combining Matching Scores in Identification Model in 8th International Conference on Document Analysis and Recognition (ICDAR 2005), Seoul, Korea, 2005. The concept is that instead of looking at the single best matching score in order to decide whether to accept the results of recognitions, the system additionally considers other scores for such decisions, e.g. second best score. Such necessity is caused by the interdependence between matching scores produced during single identification trials. Similar identification models may be used during the fusion of the biometric matchers.

The effect of identification model is the normalization of the matcher's scores with respect to the set of identification trial scores. This normalization accounts for the dependence of scores on the same input during identification trial. System 15 is different from previously investigated background models that produce user-specific combination algorithms. Identification model is a user generic algorithm that is easier to train in the biometric problems with large number of classes. FIG. 19 shows the general structure of combinations utilizing identification models; the score sᵢ^{j} is normalized first with respect to all scores of classifier j produced during current identification trial, and then normalized scores from all classifiers are fused together.

A means for representing the identification models by means of the statistics tᵢ^{j} of the identification trial scores was developed. The following statistics were used: tᵢ^{j} is the second best score besides sᵢ^{j} in the set of current identification trial scores (s₁^{j}, . . . , s_{N}^{j}). Though tᵢ^{j} can be some other statistics, the experiments in finding correlation between genuine scores and different similar statistics indicated that this particular statistic should have good performance. The system adjusts two combination algorithms, likelihood ratio and weighted sum, to use identification models. The likelihood ratio is the optimal combination rule for verification systems, selecting

$$arg {max}_{k} {\prod }_{j} \frac{p ( {s}_{k}^{j} \vert {C}_{k} )}{p ( {s}_{k}^{j} \vert {\overline{C}}_{k} )}$$

where Cₖ means that k is the genuine class. The adjusted likelihood ratio rule with identification model selects

$$arg {max}_{k} {\prod }_{j} \frac{p ( {s}_{k}^{j} , {t}_{k}^{j} \vert {C}_{k} )}{p ( {s}_{k}^{j} , {t}_{k}^{j} \vert {\overline{C}}_{k} )} .$$

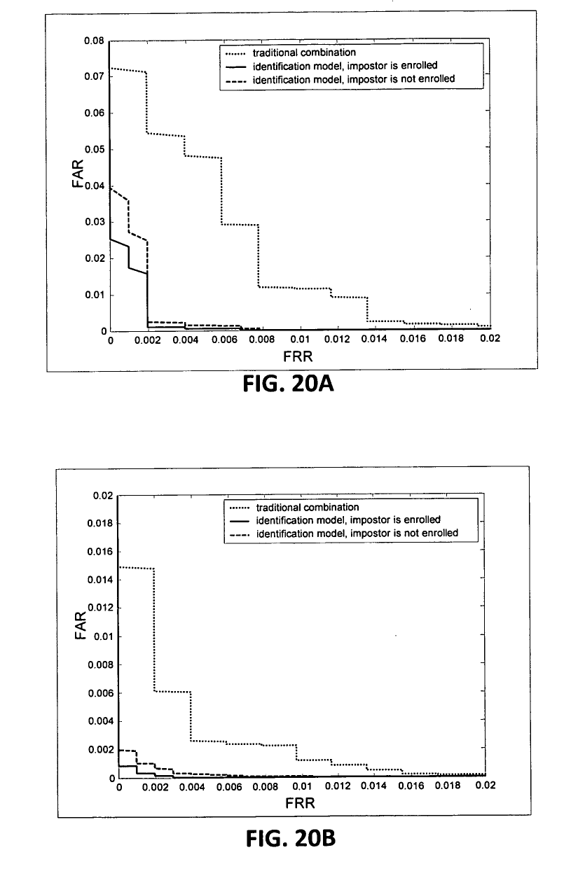

Parzen kernel density approximation is used (as in previous section) of p(*|Cₖ) and p(*| C̅ₖ). The results of the experiments on 517×517 BSSR1 set are shown in FIG. 20A-B. As shown, the use of identification model provides substantial improvements to the biometric verification system performance.

In order to judge the use of identification models in identification systems in addition to likelihood ratio combination method, the system uses weighted sum combination method. Weighted sum selects class

$$arg {max}_{k} {\sum }_{j} {w}_{j} {s}_{k}^{j}$$

where weights wⱼ are trained so that the number of misclassifications is minimized. The adjusted weighted sum rule selects class

$$arg {max}_{k} {\sum }_{j} ( {w}_{j}^{s} {s}_{k}^{j} + {w}_{j}^{t} {t}_{k}^{j} )$$

with similarly trained weights.

TABLE 9
The numbers of incorrectly identified persons for 6000 identification
trials in BSSR1 score set, li and ri are left and right index fingerprints,
C and G are two face matchers.

| | | Likelihood | | Weighted |
|---|---|---|---|---|
| | | Ratio + | | Sum + |
| | Likelihood | Identification | Weighted | Identification |
| Configuration | Ratio | Model | Sum | Model |
| li & C | 75 | 74 | 70 | 65 |
| li & G | 101 | 92 | 122 | 95 |
| ri & C | 37 | 31 | 30 | 25 |
| ri & G | 52 | 41 | 67 | 48 |

The results of experiments are shown in Table 9. While experiments on original 517×517 BSSR1 set were conducted, newer experiments using bigger BSSR1 sets were used as they are more reliable. In these experiments, the 50 impostors were chosen randomly for each identification trial. The experiments confirm the usefulness of identification model for combinations in identification systems. The results of this research are summarized in Tulyakov S. & Govindaraju V., Classifier Combination Types for Biometric Applications, IEEE Computer Society Workshop on Biometrics, New York, 2006 and Tulyakov S. & Govindaraju V., Identification Model for Classifier Combinations, Biometrics Consortium Conference, Baltimore Md., 2006. Thus, biometric recognition of the individual, as described above, can aid the system by recalling past measurements or interviews where person-specific deceit or verity instances have been previously captured.

Increases in heart rate, respiration, perspiration, blinking and pupil dilation indicate excitement, anger or fear. Detection of this ANS activity can be valuable, as it is suspected that liars have a very difficult time controlling these systems. Thus, system 15 may include sensors added to detect slight variations in perspiration. ANS activity such as heart and respiration rates can be measured acoustically, or in the microwave RF range, and such data 43 included in the analysis 46. See Nishida Y., Hori T., Suehiro T. & Hirai S., Monitoring of Breath Sound under Daily Environment by Ceiling Dome Microphone, In Proc. Of 2000 IEEE International Conference on System, Man and Cybernetics, pg. 1822-1829, Nashville, Tenn., 2000; Staderini E., An UWB Radar Based Stealthy ‘Lie Detector’, Online Technical Report, www.hrvcongress.org/second/first/placed_{—}3/Staderini_Art_Eng.pdf. There are many established computer vision approaches for the measurement of blink rates, and pupil dilation may also be a data input 43 given camera resolution and view. The results of such analysis are then mathematically fused with the face and voice deceit results to provide a combined indication of deceit or verity.

While there has been described what is believed to be the preferred embodiments of the present invention, those skilled in the art will recognize that other and further changes and modifications may be made thereto without departing from the spirit of the invention. Therefore, the invention is not limited to the specific details and representative embodiments shown and described herein. Accordingly, persons skilled in this art will readily appreciate that various additional changes and modifications may be made without departing from the spirit or scope of the invention. In addition, the terminology and phraseology used herein is for purposes of description and should not be regarded as limiting. All documents referred to herein are incorporated by reference into the present application as though fully set forth herein.

What is claimed is:

1. A computerized method for detecting truth or deceit comprising the steps of:
providing a video camera adapted to record images of a subject's face;
recording images of said subject's face;
providing a mathematical model of a face defined by a set of facial feature locations and textures;
providing a mathematical model of facial behavior that correlates to truth or deceit;
comparing said facial feature locations to said image to provide a set of matched facial feature locations;
comparing said mathematical model of facial behaviors to said matched facial feature locations; and
providing a deceit indication as a function of said comparison.

2. The method set forth in claim 1, wherein said camera detects light in the visual spectrum.

3. The method set forth in claim 1, wherein said camera detects light in the infrared spectrum

4. The method set forth in claim 1, wherein said camera is a digital camera.

5. The method set forth in claim 1, wherein said camera provides an analog signal and further comprising the step of digitizing said signal.

6. The method set forth in claim 1, wherein said image comprises a matrix of pixels.

7. The method set forth in claim 6, wherein said pixels are comprised of a set of numbers coincidentally spacially located in a matrix associated with said image.

8. The method set forth in claim 6, wherein said pixels are defined by a set of three numbers and said numbers are associated with red, green and blue values.

9. The method set forth in claim 1, wherein said facial behavior is selected from a group consisting of anger, sadness, fear, enjoyment and symmetry.

10. The method set forth in claim 9, wherein said facial behavior is anger and comprises a curvature of the mouth of the subject.

11. The method set forth in claim 9, wherein said facial behavior is sadness and comprises relative displacement of points on a mouth and a change in pixel values on or about a forehead.

12. The method set forth in claim 9, wherein said facial behavior is enjoyment and comprises relative displacements of points on a mouth and a change in pixel values in a vertical direction near the corner of an eye.

13. The method set forth in claim 9, wherein said facial behavior is fear and comprises a change in pixel values on or about a forehead.

14. The method set forth in claim 1, wherein said step of comparing said facial feature locations to said image comprises modifying said model facial feature locations to correlate to said image.

15. The method set forth in claim 1, wherein said step of comparing said facial feature locations to said image comprises modifying said image to correlate to said model.

16. The method set forth in claim 1, wherein said step of comparing said facial feature locations to said image comprises converging said model to said image.

17. The method set forth in claim 1, wherein said step of comparing said mathematical model of facial behaviors to said matched facial feature locations is a function of pixel values.

18. The method set forth in claim 1, wherein said deceit indication is provided on a frame-by-frame basis.

19. The method set forth in claim 18, and further comprises the step of filtering deceit indication values over multiple frames.

20. The method set forth in claim 1, wherein said deceit indication is a value between zero and one.

21. The method set forth in claim 1, wherein said deceit indication is a function of an audio deceit indicator.

22. The method set forth in claim 1, wherein said deceit indication is a function of facial symmetry.

23. The method set forth in claim 1, wherein said deceit indication is a function of speed of facial change.

24. An system for detecting truth or deceit comprising:
a video camera adapted to record images of a subject's face;
a processor communicating with said video camera;
said processor having a mathematical model of a face defined by a set of facial feature locations and textures and a mathematical model of facial behavior that correlates to truth or deceit;
said processor programmed to:
compare said facial locations to said image to provide a set of matched facial feature locations,
compare said mathematical model of facial behaviors to said matched facial feature locations, and
provide a deceit indication as a function of said facial comparison.

25. The system set forth in claim 24, and further comprising a microphone for recording said subject's voice, said microphone communicating with said processor and said processor programmed to provide a voice deceit indication.

26. The system set forth in claim 25, wherein said deceit indication is a function of said facial comparison and said voice deceit indication.

27. The system set forth in claim 24, and further comprising a biometric database, said processor programmed to identify biometric information in a database of information for said subject.

28. The system set forth in claim 24, wherein said camera detects light in the visual spectrum.

29. The system set forth in claim 24, wherein said camera detects light in the infrared spectrum

30. The system set forth in claim 24, wherein said camera is a digital camera.

31. The system set forth in claim 24, wherein said camera provides an analog signal and further comprising a digitizer for said signal.

32. The system set forth in claim 24, wherein said image comprises a matrix of pixels.

33. The system set forth in claim 32, wherein said pixels are comprised of a set of numbers coincidentally spacially located in a matrix associated with said image.

34. The system set forth in claim 32, wherein said pixels are defined by a set of three numbers and said numbers are associated with red, green and blue values.

35. The system set forth in claim 24, wherein said facial behavior is selected from a group consisting of anger, sadness, fear, enjoyment and symmetry.

36. The system set forth in claim 35, wherein said facial behavior is anger and comprises a curvature of the mouth of the subject.

37. The system set forth in claim 35, wherein said facial behavior is sadness and comprises relative displacement of points on a mouth and a change in pixel values on or about a forehead.

38. The system set forth in claim 35, wherein said facial behavior is enjoyment and comprises relative displacements of points on a mouth and a change in pixel values in a vertical direction near the corner of an eye.

39. The system set forth in claim 35, wherein said facial behavior is fear and comprises a change in pixel values on or about a forehead.

40. The system set forth in claim 24, wherein said processor is programmed to modify said model facial feature locations to correlate to said image.

41. The system set forth in claim 24, wherein said processor is programmed to modify said image to correlate to said model.

42. The method set forth in claim 24, wherein said processor is programmed to converge said model to said image.

43. The system set forth in claim 24, wherein said deceit indication is provided on a frame-by-frame basis.

44. The system set forth in claim 43, wherein said processor is programmed to filter deceit indication values over multiple frames.

45. The system set forth in claim 24, wherein said deceit indication is a value between zero and one.

46. The system set forth in claim 24, wherein said deceit indication is a function of an audio deceit indicator.

47. The system set forth in claim 24, wherein said deceit indication is a function of facial symmetry.

48. The system set forth in claim 24, wherein said deceit indication is a function of speed of facial change.

49. A computer readable medium having computer-executable instructions for performing a method comprising:
providing a mathematical model of a face defined by a set of facial feature locations and textures;
providing a mathematical model of facial behavior that correlates to truth or deceit;
comparing said facial feature locations to a video image of a subject's face to provide a set of matched facial feature locations;
comparing said mathematical model of facial behaviors to said matched facial feature locations; and
providing a deceit indication as a function of said comparison.

50. The medium set forth in claim 49, wherein said facial behavior is selected from a group consisting of anger, sadness, fear, enjoyment and symmetry.

51. The medium set forth in claim 50, wherein said facial behavior is anger and comprises a curvature of the mouth of the subject.

52. The medium set forth in claim 50, wherein said facial behavior is sadness and comprises relative displacement of points on a mouth and a change in pixel values on or about a forehead.

53. The medium set forth in claim 50, wherein said facial behavior is enjoyment and comprises relative displacements of points on a mouth and a change in pixel values in a vertical direction near the corner of an eye.

54. The medium set forth in claim 50, wherein said facial behavior is fear and comprises a change in pixel values on or about a forehead.

55. The medium set forth in claim 49, wherein said step of comparing said facial feature locations to said image comprises modifying said model facial feature locations to correlate to said image.

56. The medium set forth in claim 49, wherein said step of comparing said facial feature locations to said image comprises modifying said image to correlate to said model.

57. The medium set forth in claim 49, wherein said step of comparing said facial feature locations to said image comprises converging said model to said image.

58. The medium set forth in claim 49, wherein said step of comparing said mathematical model of facial behavior to said matched facial feature locations is a function of pixel values.
